(19) United States
(12) Patent Application Publication
(10) Pub. No.: US 2011/0060604 A1
(43) Pub. Date: Mar. 10, 2011

(54) METHOD OF DOCUMENTING PATIENTS' CLINICAL STATUS ACROSS MULTIPLE DIAGNOSTIC DIMENSIONS

(76) Inventors: Suresh C. Bangara, Pasadena, CA (US); Lawrence G. Feinstein, San Diego, CA (US)

(21) Appl. No.: 12/876,394

(22) Filed: Sep. 7, 2010

Related U.S. Application Data
(60) Provisional application No. 61/240,174, filed on Sep. 4, 2009.

(51) Int. Cl. G06Q 50/00; G06F 17/30; G06Q 10/00

(52) U.S. Cl. 705/2; 707/802; 707/E17.044

(57) ABSTRACT

A computer implemented method for managing a patient's clinical status. The method includes: storing rules in a database; storing clinical domains including a set of clinical variables; storing information about the patient in the database; receiving responses to one or more questions about the patient's status for one or more clinical domains. The method then generates derived variables from the stored information, the stored clinical variable and the responses to one or more questions using one or more of the stored plurality of rules; calculates stratified domain levels for one or more of the plurality of clinical domains from the stored information, the stored clinical variables and the generated derived variables; and calculates a level of urgency from the stratified domain levels and the generated derived variables.

### CROSS-REFERENCE TO RELATED APPLICATION

This patent application claims the benefit of the filing date of U.S. Provisional Patent Application Ser. No. 61/240,174, filed on Sep. 4, 2009, and entitled “Method Of Documenting Patients' Clinical Status Across Multiple Diagnostic Dimensions,” the entire content of which is hereby expressly incorporated by reference.

### FIELD OF THE INVENTION

The present invention relates generally to computer software; and more particularly to a method of documenting patients' clinical status across multiple diagnostic dimensions.

### BACKGROUND

To date there is no accepted and widely used method for capturing the clinical data necessary to perform quality-based outcomes measurement in the field of mental health treatment. Consequently, Managed Care Organizations (MCOs) have focused only on measuring utilization metrics (frequency and/or cost of services), which do not reflect efficacy of treatment and a patient's clinical improvement. Two primary factors contribute to this problem. One is the lack of agreement on a standard set of criteria to measure clinical status that is acceptable to all mental health providers across diverse schools of thought. The second is the unavailability of an easy-to-use and comprehensive methodology or technology to rapidly capture relevant clinical information needed to measure a patient's clinical improvement.

Currently, there is a high percentage of concordance between level of case (LOC) guidelines across MCOs. However, the LOC guidelines are only guidelines and are relatively vague with regard to clinical signs and symptoms. The application of LOC guidelines are subjective and depend on clinicians' interpretation of the guidelines to meet medical necessity criteria.

Inter-rater reliability (IRR) regarding the selection of a LOC for a particular case is approximately 70% across clinicians (including case managers and medical directors) in MCOs, hospitals, and provider groups. This occurs because (a) clinicians are selective and subjective about the clinical information captured about a particular case; and (b) clinicians tend to focus on varied aspects of cases based on their respective clinical training and school of thought (e.g., Cognitive Behavioral versus Psychodynamic). Consequently, clinicians do not necessarily consider all aspects of a case, which impacts decision making regarding the status, disposition and LOC of a case.

Given the absence of an acceptable quality-based methodology for measuring patients' clinical improvement, providers are subject to profiling based on traditional utilization management metrics (as defined above). Current standard quality indicators do not include whether a diagnosis selected by a clinician meets Diagnostic and Statistical Manual of Mental Disorders (DSM) criteria, whether providers use evidence-based treatment modalities, or whether treatment outcomes are adjustment for case mix (proportion of complex versus non-complex cases, diagnostic categories, and severity of cases) across providers.

### SUMMARY

In some embodiments, the present invention is a computer implemented method for managing a patient's clinical status. The method includes: storing rules in a database; storing clinical domains including a set of clinical variables; storing information about the patient in the database; receiving responses to one or more questions about the patient's status for one or more clinical domains. The method then generates derived variables from the stored information, the stored clinical variable and the responses to one or more questions using one or more of the stored plurality of rules; calculates stratified domain levels for one or more of the plurality of clinical domains from the stored information, the stored clinical variables and the generated derived variables; and calculates a level of care from the stratified domain levels and the generated derived variables.

The method may also calculate a level of urgency from the stratified domain levels and the generated derived variables.

In some embodiments, the present invention is a computer implemented method for managing a patient's clinical status. The method includes: storing rules in a database; storing clinical domains including a set of clinical variables; storing information about the patient in the database; receiving responses to one or more questions about the patient's status for one or more clinical domains. The method then generates derived variables from the stored information, the stored clinical variable and the responses to one or more questions using one or more of the stored plurality of rules; calculates stratified domain levels for one or more of the plurality of clinical domains from the stored information, the stored clinical variables and the generated derived variables; and calculates a level of urgency from the stratified domain levels and the generated derived variables.

The method may also calculate a level of care from the stratified domain levels and the generated derived variables.

The method may also generate a report based on the stored information about the patient and the calculated level of care.

In some embodiments, the present invention is a computer implemented method for managing a patient's clinical status. The method includes: storing a plurality of rules and a plurality of clinical domains in a database, each clinical domain including a set of clinical variables selected based on clinical research to describe clinical acuity and determine risk; defining a plurality of levels of care representing the patient's clinical status; receiving responses to one or more questions about the patient's status for one or more clinical domains; generating derived variables from the responses to one or more questions using one or more of the stored plurality of rules; stratifying a patient's status in each clinical domain to represent a clinical severity level for each clinical domain; joining the clinical severity levels across the plurality of clinical domains with the generated derived variables and the responses; and mapping the clinical severity levels to medical necessity criteria related to each of the plurality of levels of care; and generating a report based on the mapped the clinical severity levels and the levels of care.

### BRIEF DESCRIPTION OF THE DRAWINGS

FIG. 1 is an exemplary architectural block diagram of a software, according to some embodiments.

FIG. 2 shows a simplified security level block diagram, according to some embodiments of the present invention.

FIG. 3 shows a simplified process flow diagram, according to some embodiments of the present invention.

FIGS. 4A and 4B illustrate exemplary Lethality Domain screens, according to some embodiments of the present invention.

FIGS. 5A-5N depict various exemplary Domain screens, according to some embodiments of the present invention.

FIGS. 6A-6E show various exemplary reporting screens, according to some embodiments of the present invention.

FIGS. 7A and 7B illustrate an abbreviated example of how the four levels of rules work together to generate a recommended Level of Care based on the user's input, according to some embodiments of the present invention.

FIG. 8 shows an exemplary process flow, implemented by a computer, for comparing a user's input to a series of rules to generate the Symptom Severity domain score, according to some embodiments of the present invention.

FIG. 9 shows an exemplary process flow, implemented by a computer, for utilizing a user's input to compute derived variables, and then compared to a series of rules to generate the Lethality domain score, according to some embodiments of the present invention.

FIG. 10 illustrates an exemplary process flow, implemented by a computer, for utilizing derived variables and domain scores as input to compute and generate a Level of Care, according to some embodiments of the present invention.

### DETAILED DESCRIPTION

In some embodiments, the present invention is a computer software application, available to providers (including facilities) via a computer network, for example, the Internet, that enables providers to document and/or manage a patient's clinical status (right care at the right Level of Care and Urgency) across multiple diagnostic dimensions and verify diagnoses. The invention has embedded computerized decision processes that suggest a Level of Care and Urgency based on the information from a plurality of clinical domains. The application generates a complete clinical report including a graphical presentation that serves to track patient's progress in treatment (outcomes). Data collected using the invention creates a valuable asset to support research and development, disease management and predictive modeling, and provider profiling.

In some embodiments, the present invention performs three diverse functions in a single application: Level of Care (LOC) determination, outcomes measurement, and provider profiling.

Level of Care determinations are consistent and accurate. A lot of this is due to the user interface that leverages branching logic for rapid data capture, computerized processes that interpret the data, and the fact that the clinical information captured is mapped to standard level of care guidelines. This minimizes subjective interpretative variance. In this capacity, the invention supports disease management for disease-specific states and predictive modeling for recidivism.

The invention also supports provider profiling in a unique way based on quality measures (effectiveness of treatment) rather than utilization metrics (frequency and cost of services). In a reciprocal fashion, the invention provides ongoing training by clarifying the clinical characteristics associated with each level of care, and matching symptom profiles with correct diagnoses.

With respect to LOC decision making, the invention automates the application of LOC guidelines and adds a dimension of specificity regarding clinical signs and symptoms related to any patient condition. The present invention guides the clinician with regard to the information that is collected, and captures information across several clinical domains that are required to provide complete clinical decision-making. The invention then applies complex computerized decision making processes to the information to derive the most appropriate LOC recommendation.

With respect to the “Outcomes,” in the present invention, they are measurable because the invention captures data from several domains that define a patient's clinical status. Data for each of the several domains is quantifiable individually and in the aggregate. Improvements and decrements are quantifiable within each domain over time and across cases. In addition, data can be aggregated across the domains and quantified to provide a view of the patient's overall functioning, status and disposition. The invention enables clinicians to understand cases at both the individual domain level and, simultaneously, across all domains. This allows clinicians to understand how changes in any individual domain, or combination of domains, effects overall functioning and status.

With respect to the “Provider Profiling, Individual Providers and Facilities,” the invention supports true provider profiling based on quality indicators instead of traditional utilization management metrics (such as frequency and/or cost of services). In some embodiments, quality indicators measure diagnostic veracity (i.e., diagnostic criteria met or not met), use of evidence-based treatment modalities, and outcomes such as clinical change over time as measured by specific functionality, signs and symptoms. The invention also enables adjustment for case mix (as defined above) across providers.

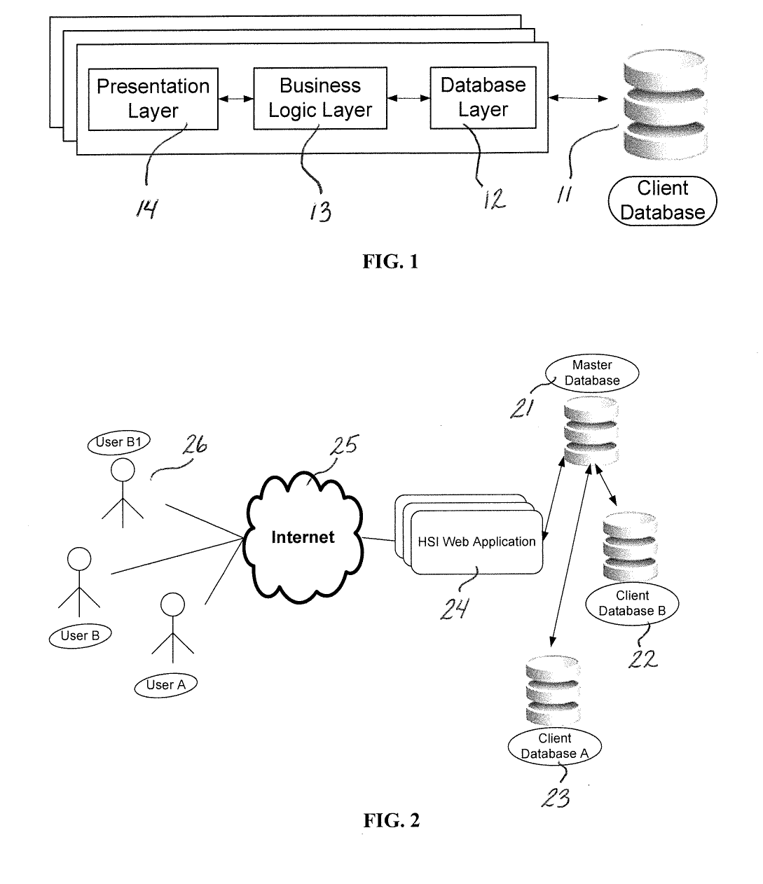

FIG. 1 is an exemplary architectural block diagram of a software, according to some embodiments. One or more client databases 11 include data related to the patients and other data such as clinical rules, level of care criteria (explained below), domain stratification logic (explained below), etc. Each database may reside on one or more computers. The users use a terminal or a computer, such as a Personal Computer (PC) to access the software of the present invention running on one or more servers, through a computer network, such as the Internet.

A Presentation Layer 14 provides support for the interactions between the actors, or the users of the system, and the software system itself through the presentation of user interfaces. A Business Logic Layer 13 provides support for application specific business processes, as well as, the application and enforcement of business and data integrity rules. A Data Access (Database) Layer 12 provides support for data access and persistence in conjunction with the client databases 11.

With respect to directional dependencies, and based upon the hierarchical structure of the responsibility-based layers design pattern, the Presentation Layer 14 initiates communication with the Business Logic Layer 13 and, occasionally, the Data Access Layer 12. Similarly, the Business Logic Layer initiates communication with the Data Access (Database) Layer 12, which initiates communication with the client databases 11. It is noted that when reference to “a database,” is made, as one skilled in the art would readily recognize, the database, may be a combination of one or more databases residing on one or more computers that may be connected via a computer network, for example, a distributed database. Each of these layers is comprised of numerous classes.

FIG. 2 shows a simplified security level block diagram, according to some embodiments of the present invention. The security system operates at three levels: master database level, client database level, and record level. In some embodiments, at the client database level, separate databases are used for each licensed facility, hospital, provider group, or managed care company, for example, Client Database A 23 and Client Database B 22, as shown. In some embodiments, for individual users who purchase a monthly user subscription and are not part of a hospital, group, etc., a single aggregate database may be used. Within the aggregate user database, individual providers can access only the records they create; they cannot view any record created by another user, even if the same patient sees more than one provider.

Within a client database (licensed to a facility, hospital, provider group, or managed care company), users may be assigned a security level: High, Medium, or Low. Patient records are also assigned a security level: High, Medium, or Low. Users 26 can access all patient records at or below their own security level via the Internet 25 and through a web application 24 running on one or more server computers. For example, a user with a Medium security level can view on her terminal display all patient records with a security level of Medium or Low.

A Master Database 21 is used above the individual client databases and the aggregate user database to manage login credentials for each user, and the association between the user and one client database or the aggregate user database. In some embodiments, each user login is associated with only one database.

In some embodiments, users login to a Web application according to the invention through the Internet. Login credentials for each user are stored in the Master database 21. Once a user's credentials are verified in the Master database 21, the software application of the present invention links the user to their corresponding database. For example, as illustrated in FIG. 2, when User A logs in to the application 24, his credentials are verified in the Master database 21. Upon verification, the user's session is directed to Client Database A 23.

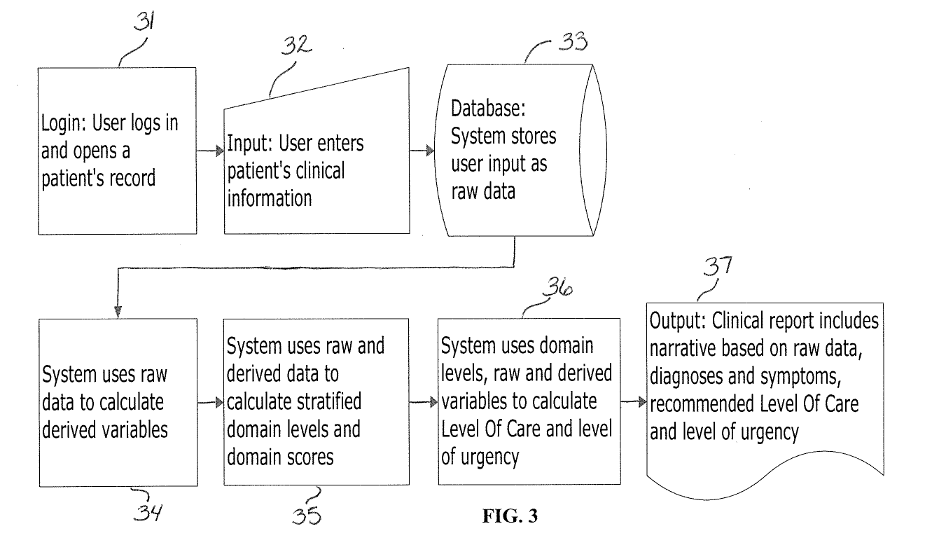

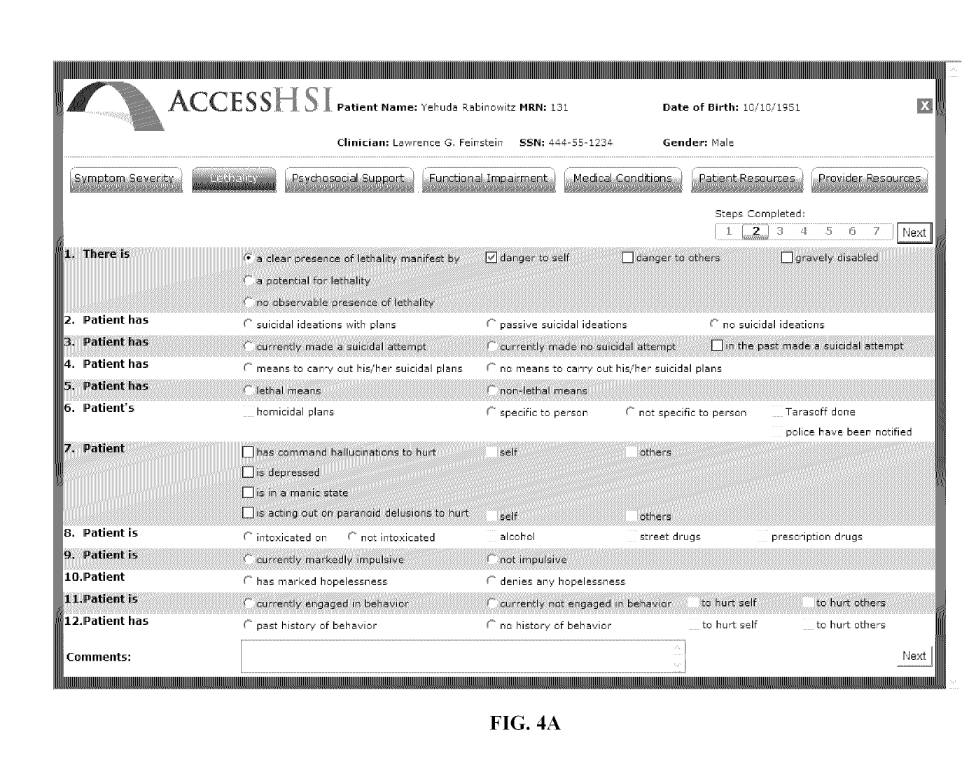

FIG. 3 shows a simplified process flow diagram, according to some embodiments of the present invention. In some embodiments, the variable mapping and decision logic (rules) are accomplished on four separate levels and combined in a single application. Individual item responses record users' input and support user interface screen controls to speed data input, in level 1. Derived variables are generated from combinations of individual item responses using computational process, rules and Boolean logic, in level 2. In level 3, severity scores are generated for each of the seven domains, from 1 (lowest severity) through 4 (highest severity), based on derived variables and individual item responses. Finally, in level 4, Level of Care (LOC) decisions are based on combinations of domain severity scores, derived variables, and individual item responses.

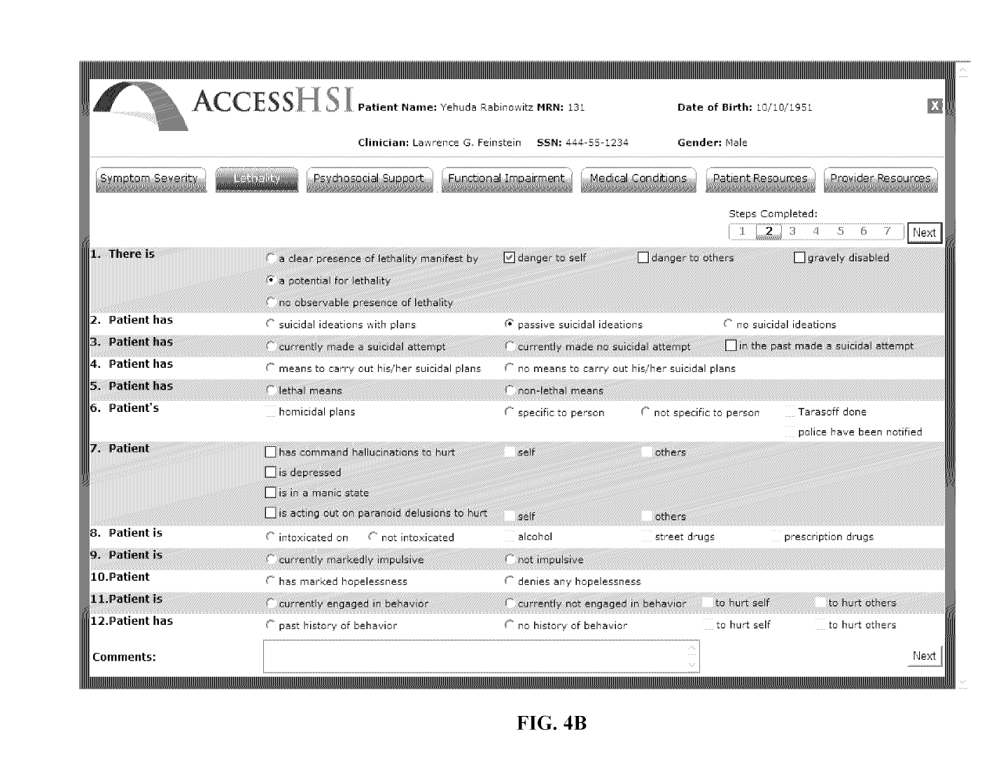

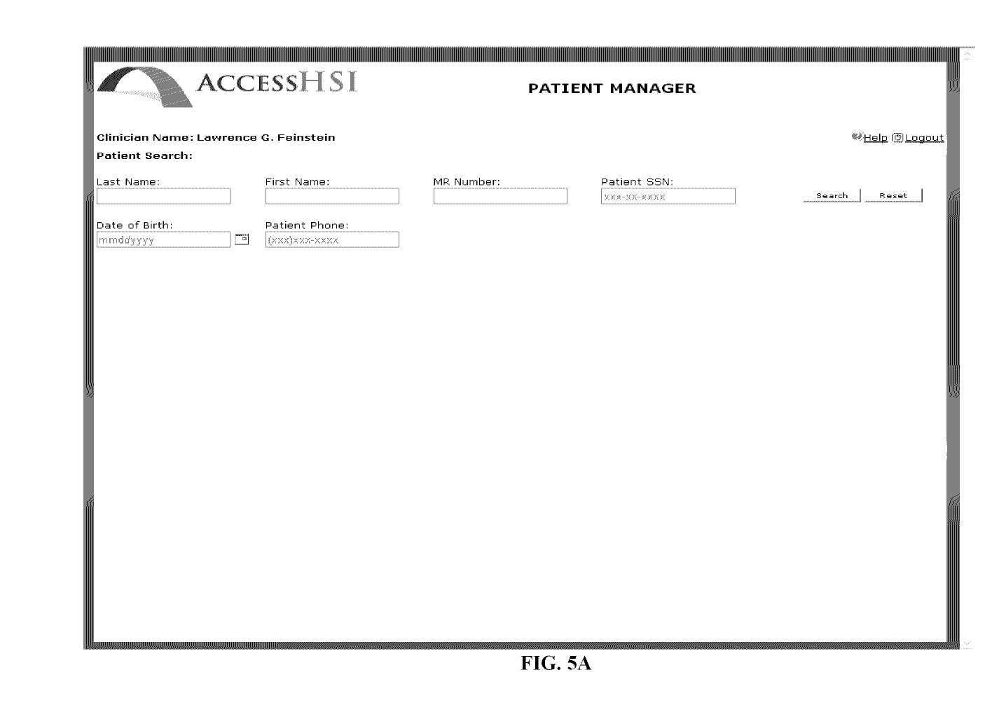

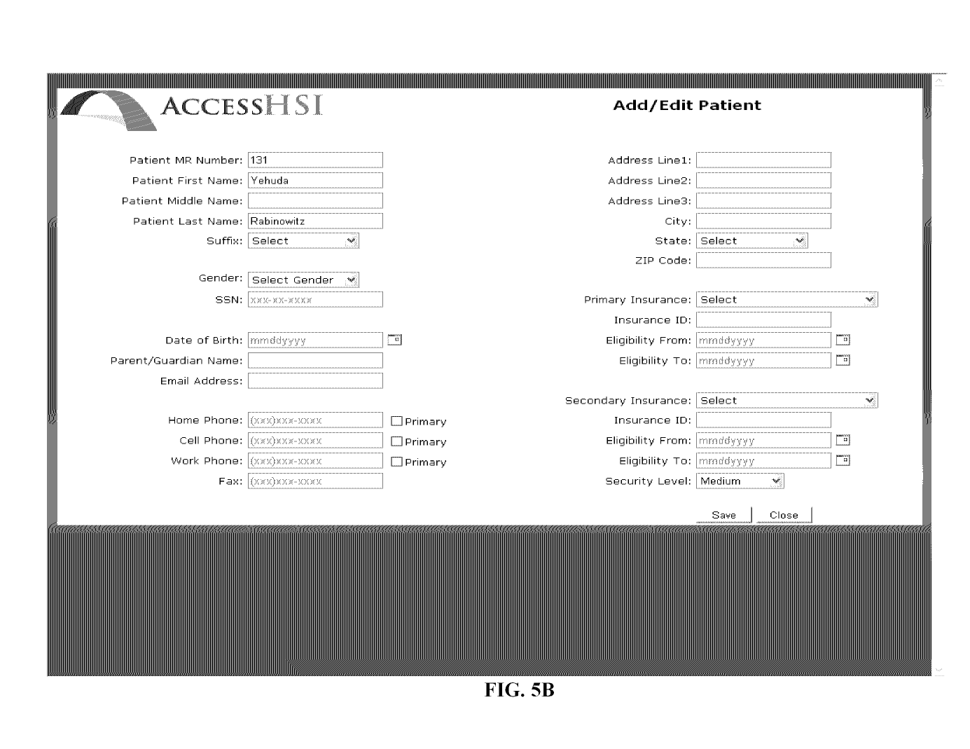

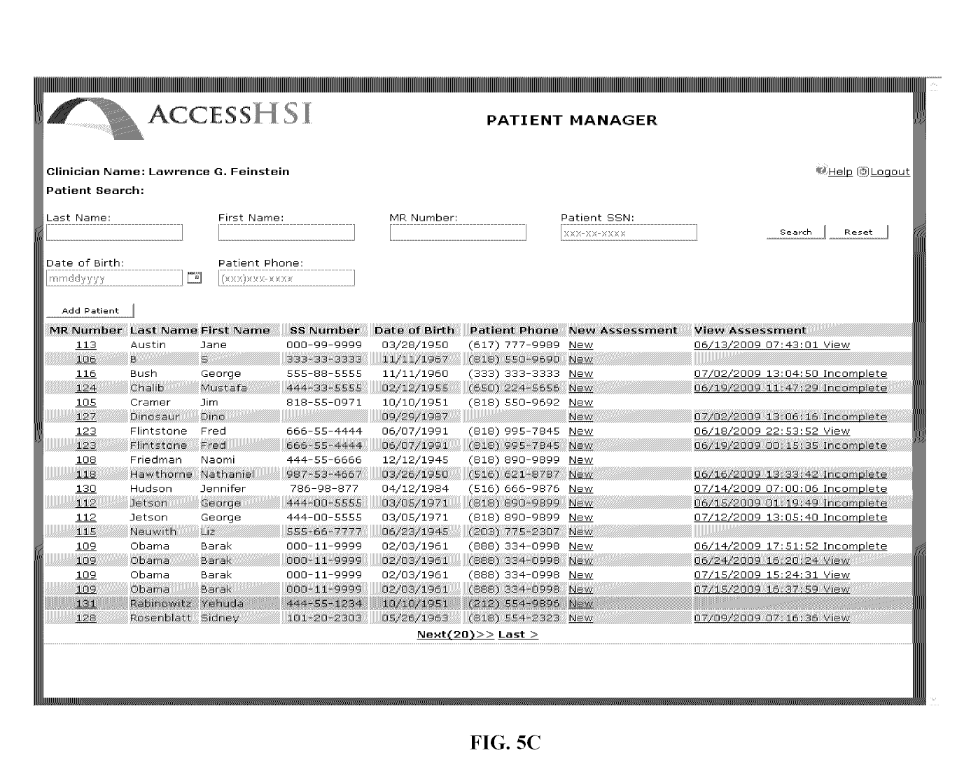

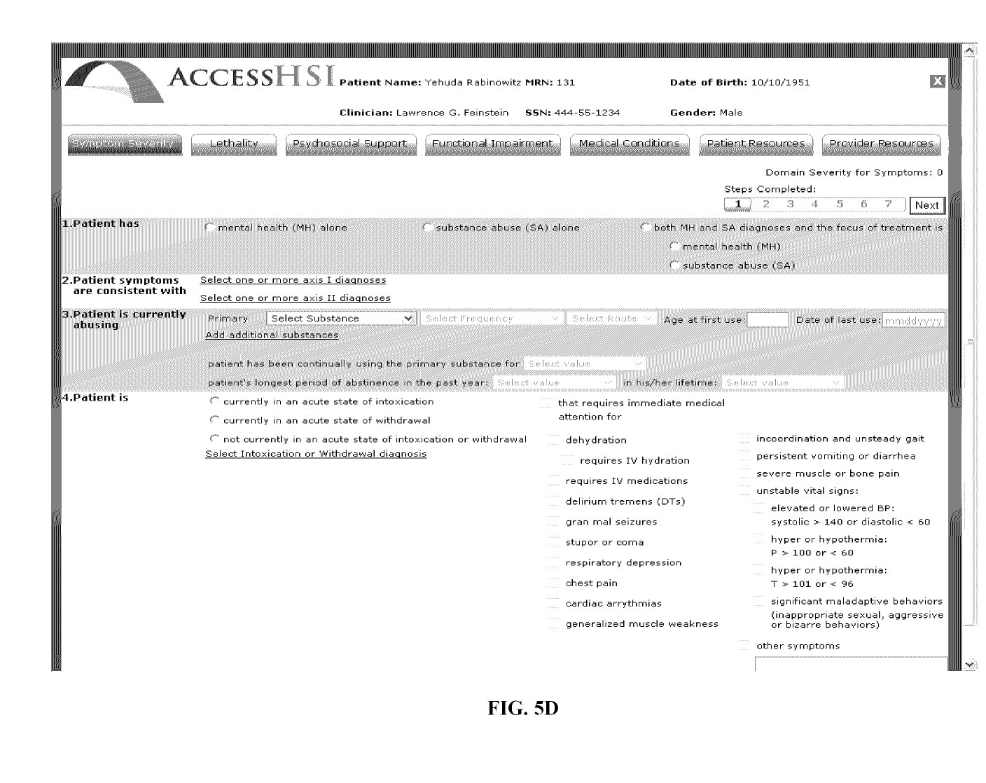

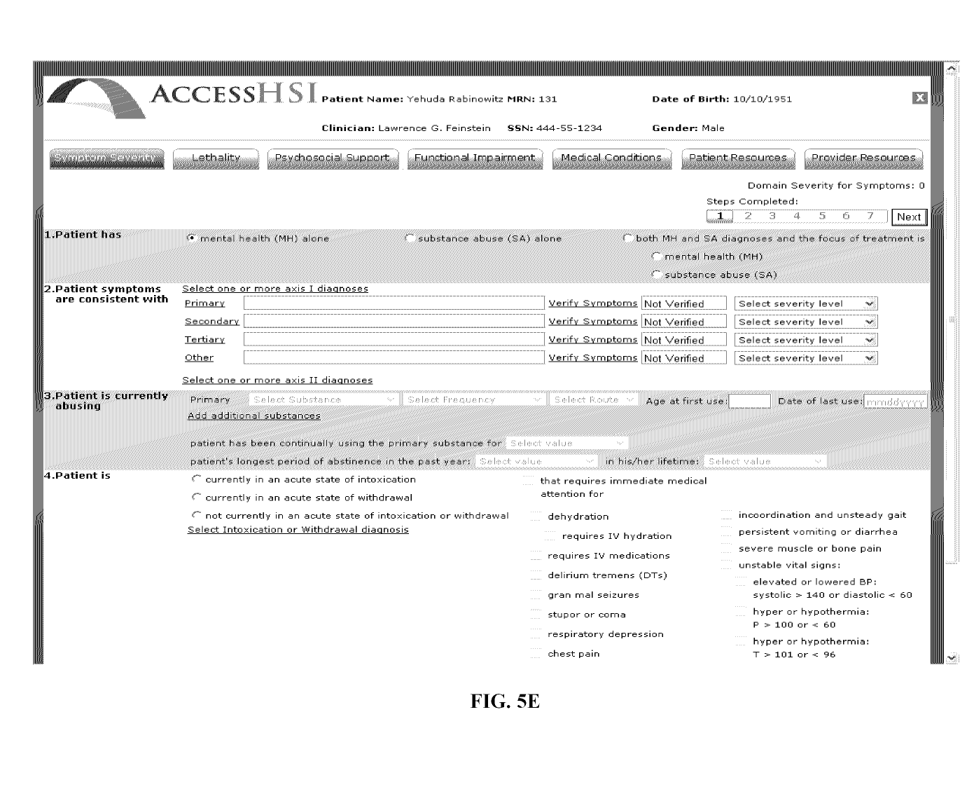

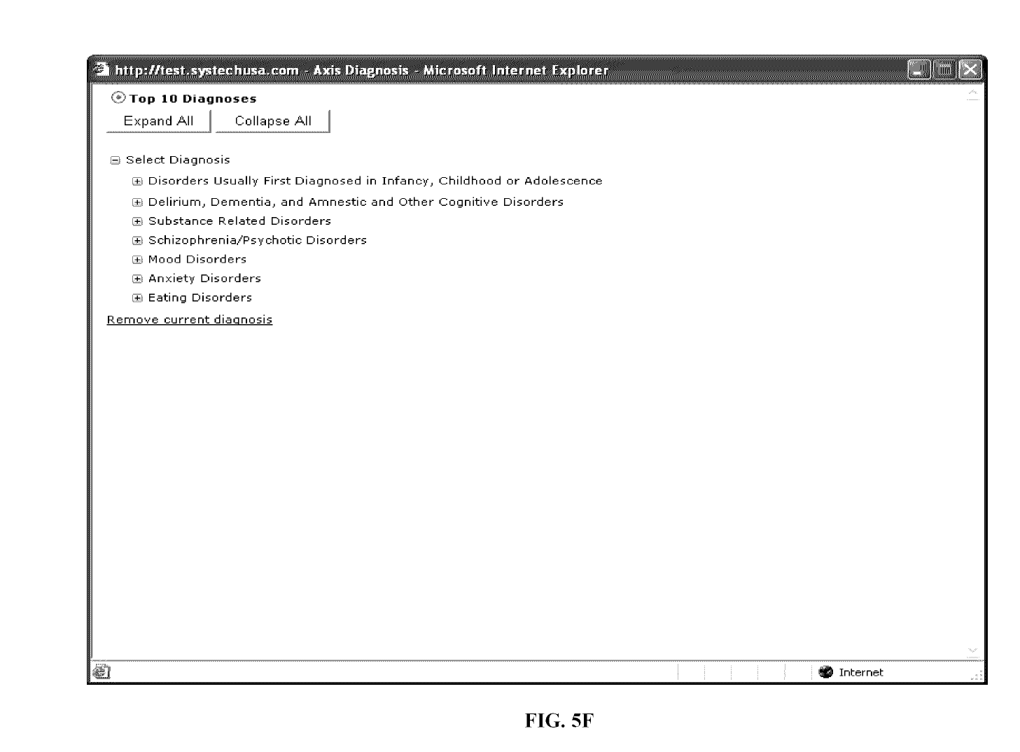

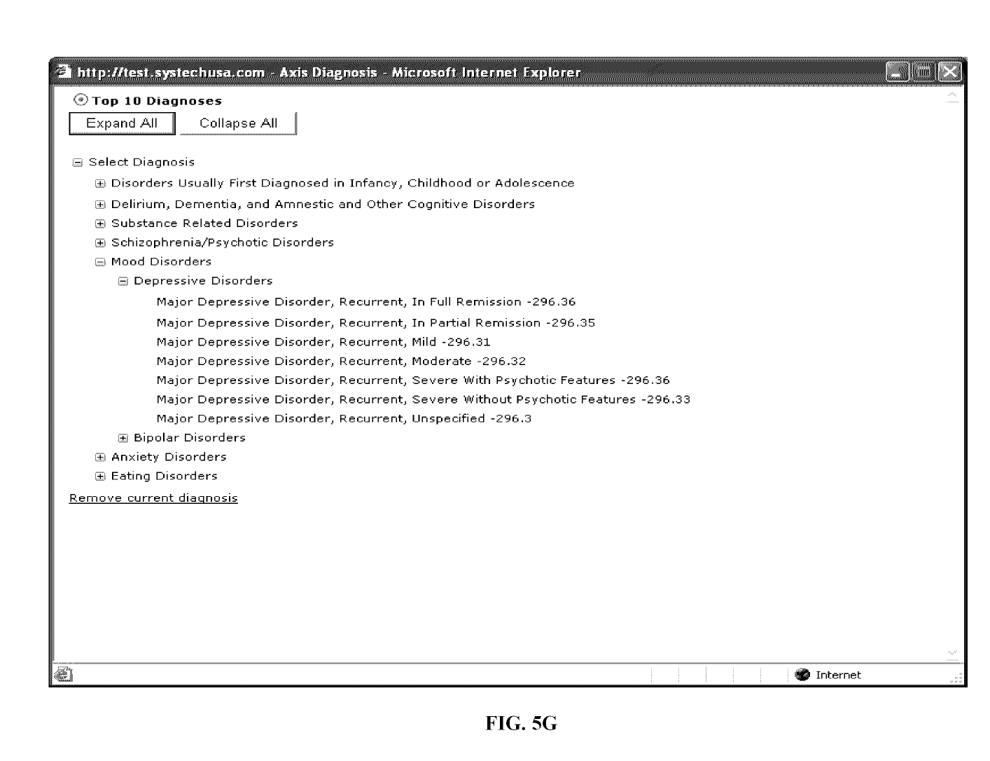

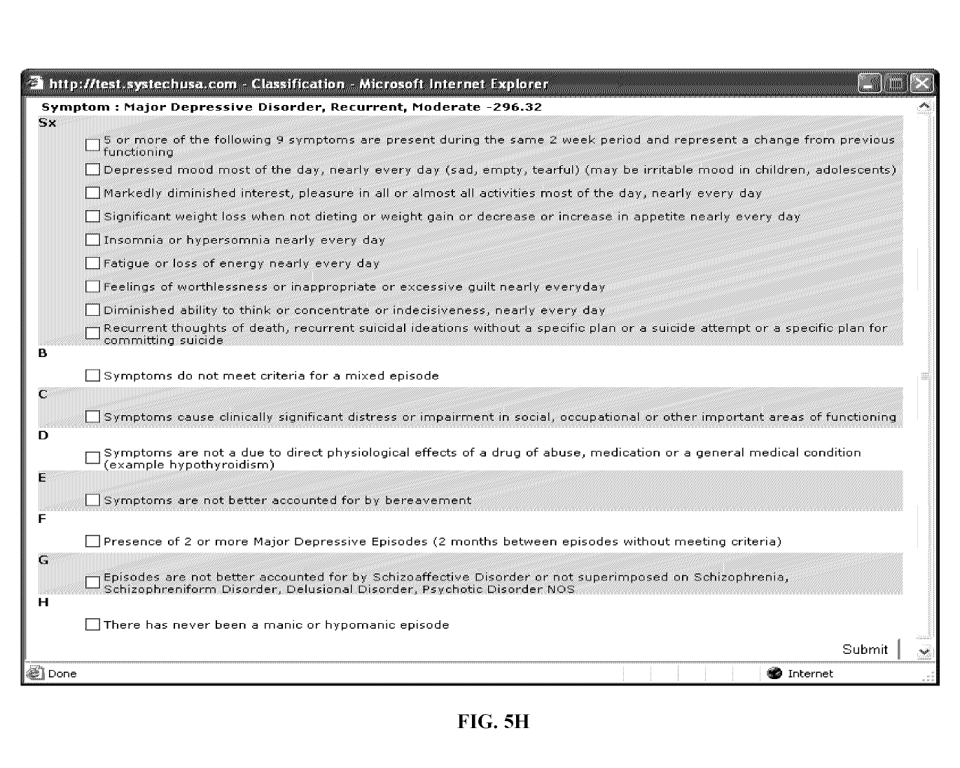

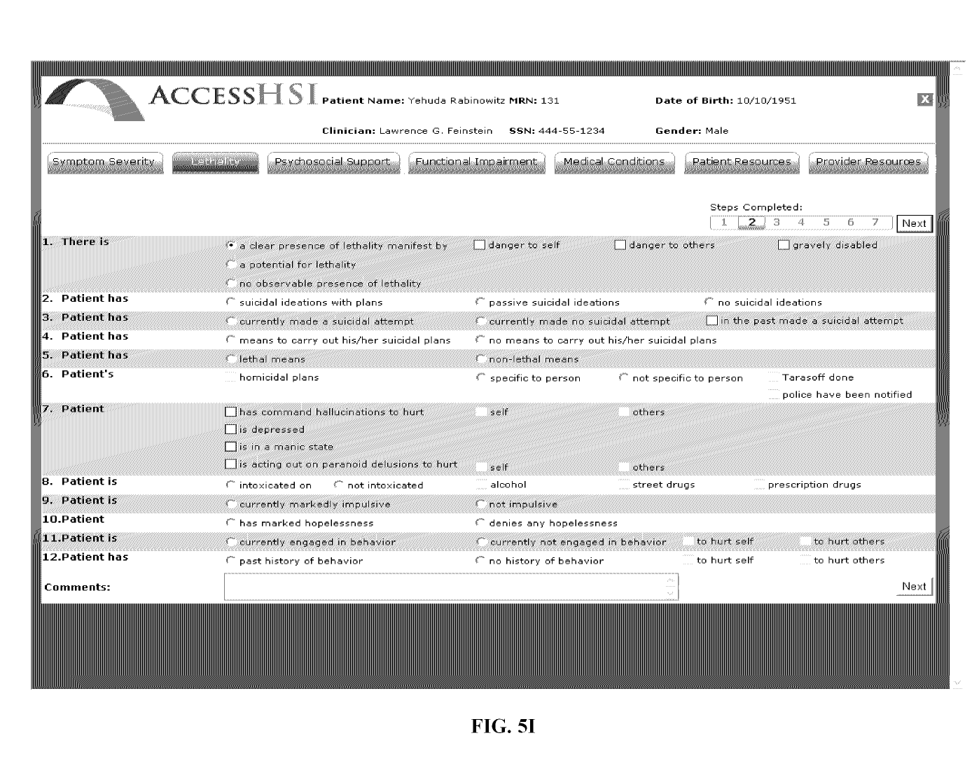

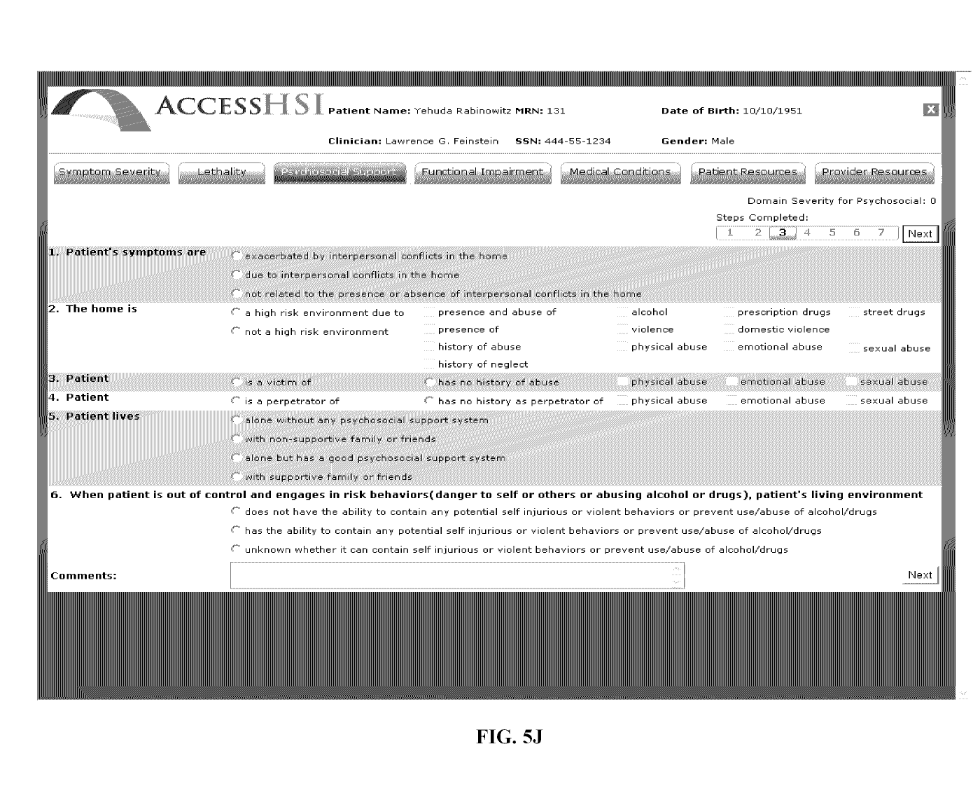

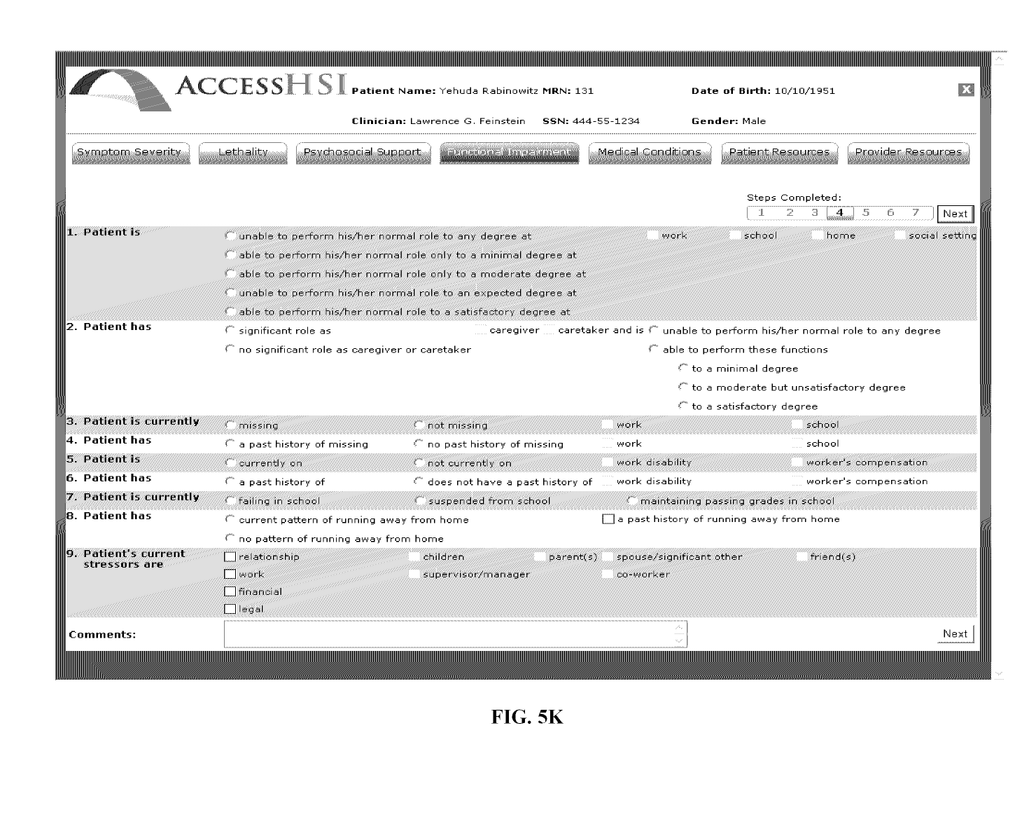

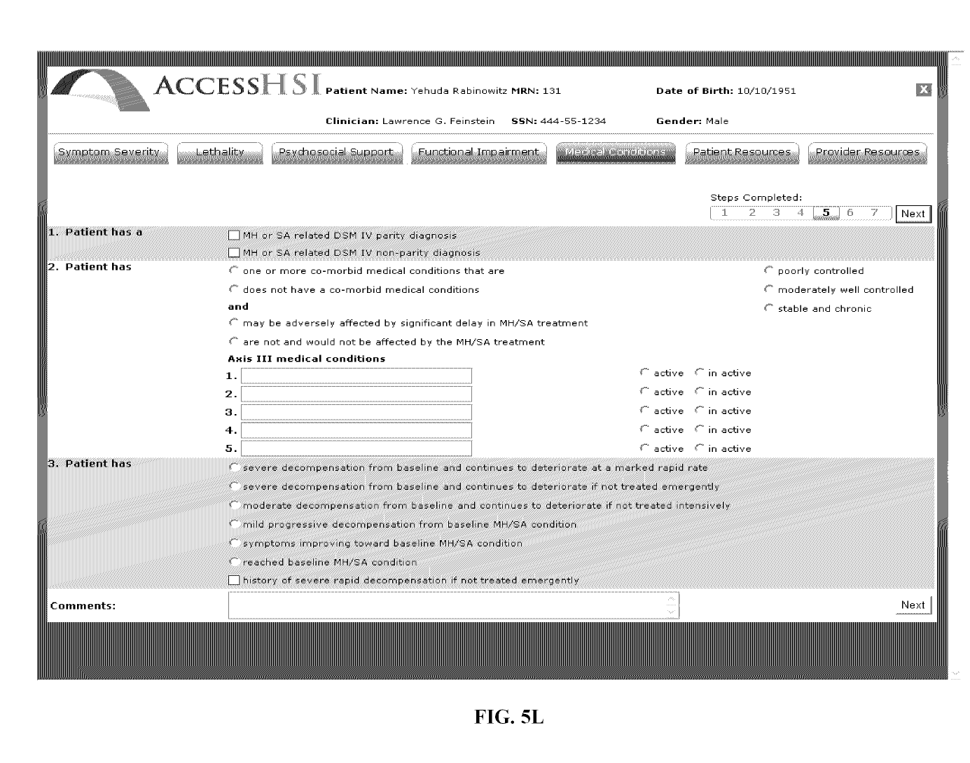

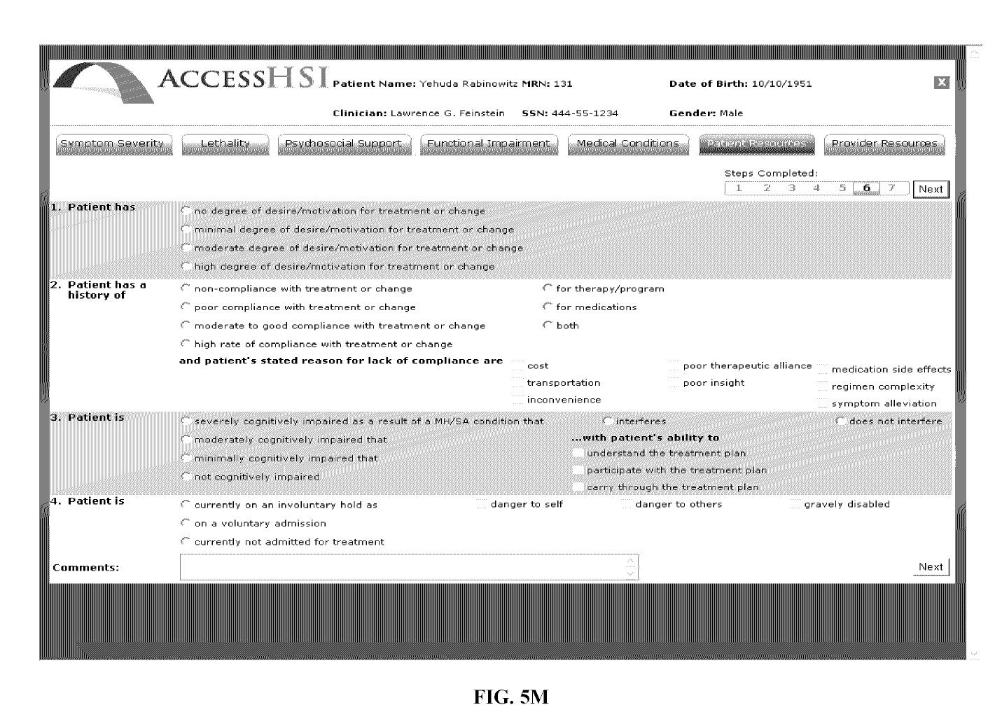

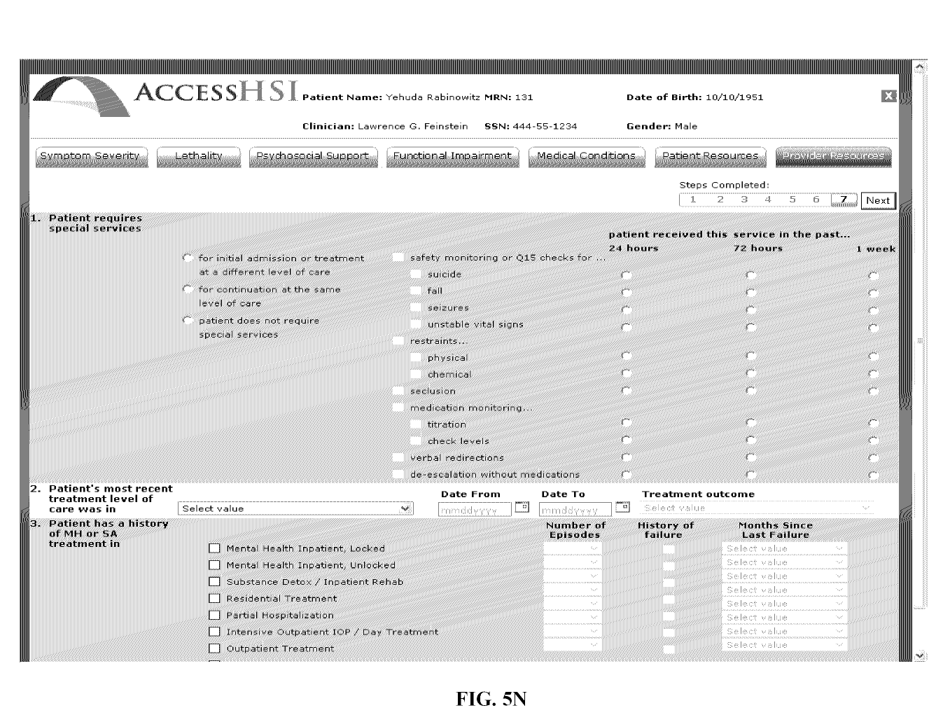

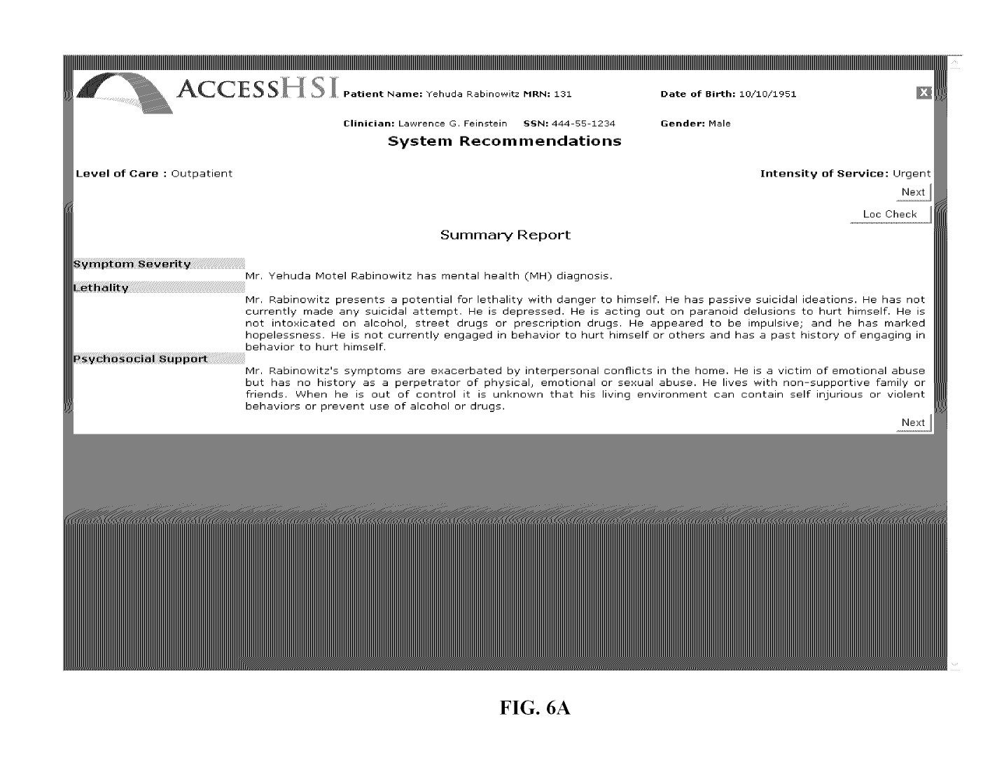

As shown, the user (for example, a managed care personnel) logs in and opens a patient's record, in block 31. In block 32, the user enters patient's clinical information. Some examples of patient's clinical information is depicted in FIG. 4A and described below. The one or more databases then stores the patient's information, for example, as raw data (block 33). The invention then uses the stored patient's information to calculate derived variables, in block 34. The derived variables are generated from combinations of individual item responses using computational processes, rules and Boolean logic. The invention then uses the stored patient's information and the derived variables to calculate stratified domain levels and domain scores (described in detail below), in block 35. In block 36, invention uses the stored patient's information, the derived variables, and the calculated domain levels to calculate (recommend) LOC and/or level of urgency. Finally, the invention generates a report including narratives, based on the patient's information, diagnoses and symptoms recommended LOC and/or level of urgency, in block 37. FIGS. 5D through 5H illustrate how Diagnoses and Symptoms related to a particular Diagnosis is gathered.

In some embodiments, the derived variables in the calculated domain levels determine the domain scores, as each item/variable has a score. The domain scores are used to track outcomes, identify high risk patients in a disease state (disease management) and for predictive modeling).

In some embodiments, the clinical logic begins by defining wellness and illness as a continuum in any given population. The assumption is that everybody moves from wellness to a state of illness and perhaps back and forth between wellness and illness. Hence, the wellness and illness is a continuum. Further, an individual person's health status is defined and recorded using, for example, seven domains, each having a display screen for entering, displaying and editing the data.

1. Symptom Severity

2. Lethality

3. Psychosocial Support

4. Functional Impairment

5. Medical Co-morbidity

6. Patient Resources

7. Provider Resources

Each domain has a specific set of clinical variables. These variables are selected on the basis of community standards and clinical research as being the most relevant to describe clinical acuity (highest to lowest), and determine risk (greatest to least) for morbidity/illness or wellness. The format, wording and order of the variables are designed, tested, and refined to maximize speed of data input, and make the software application as intuitive as possible regardless of users' clinical orientation.

In other words, the invention stores rules, clinical domains including a set of clinical variables, and information about the patient in one or more databases. The invention then receives responses to one or more questions about the patient's status for one or more clinical domains, utilizing, for example graphical user interfaces (GUIs). The invention then generates derived variables from the stored information, the stored clinical variable and the responses to one or more questions using one or more of the stored plurality of rules, calculates stratified domain levels for one or more of the plurality of clinical domains from the stored information, the stored clinical variables and the generated derived variables; and calculates a level of care and or a level of urgency from the stratified domain levels and the generated derived variables. A report may also be generated providing the calculated information to the users in an effective way.

In some embodiments, embedded in each domain screen is a screen control logic that guides users through the questions based on their responses to previous items. The branching logic disables questions that are not necessary or clinically inconsistent with users' answers on previous questions within and across domains; users simply skip the disabled items. Similarly, within questions, the branching logic enables “child” options based on users' responses to “parent” options, thereby visually guiding users through predetermined logic paths encoded within the questions.

FIGS. 4A and 4B illustrate exemplary Lethality Domain screens, according to some embodiments of the present invention. As an example, when the Lethality domain screen (shown in FIG. 4A) first appears, the check boxes labeled “Danger to Self”, “Danger to Others”, and “Gravely Disabled” are all disabled. Only when the user selects either a button labeled “a clear potential for lethality manifested by” or a button labeled “potential for lethality,” the check boxes are enabled for the user to select “Danger to Self”, “Danger to Others”, and/or “Gravely Disabled”. If the user selects “Danger to Self” but not “Danger to Others”, the user interface disables questions related to danger to others but, it enables all items related to danger to self such as ideations with plans, available means, lethality of means, impulsivity and hopelessness.

For example, in the Lethality screen, the item in question 1 is marked positive, meaning that the patient has a clear presence of lethality manifest by Danger to Self Subsequent questions, for example questions 2, provide choices about the seriousness of the suicidal ideation, question 4 and 5 about the viability of means to follow through on a suicidal plan and asks if the means are by lethal or non-lethal means, and questions 7 and 8 are associated risk factors for somebody potentially following through and making such an attempt.

Then, if the user indicates that the patient has “passive suicidal ideations” instead of “suicidal ideations with plans”, items related to availability and lethality of means disable because they are clinically inconsistent with passive suicidal ideation, as shown in FIG. 4B.

A second level of logic is a set of derived variables that are generated from combinations of individual item responses using computational processes, rules and Boolean logic. Derived variables include:
a) number of Axis I and Axis II diagnoses by verification status by severity level;
b) risk for lethality based on impulsivity, depression, command hallucinations, manic state, paranoid delusions, and intoxication;
c) risk for lethality plus past history of engaging in behavior to harm self or others plus whether the patient's social environment can provide protection against harmful behaviors;
d) the degree of risk in the home as a function of drugs, violence, abuse, and neglect; and
e) number of blank and non-blank domains.

These variables are used in support of higher levels of decision logic.

A third level of logic is the stratification of the patient's status in each domain. Individual variables and derived variables are joined in a series of Boolean processes (“and” statements, “or” statements, etc.) to represent all possible combinations of responses that represent clinical severity at one of, for example, four levels of severity. Individual or clinical variables are each of the data elements which are clinical in nature, and displayed in each of the multiple questions shown in each page/domain/screen. Derived variables are when the invention clusters the individual variables in some clinical sets or groupings that allow us to stratify the groups into four levels of clinical severity and provide a “derived value”. Inconsistent combinations of items are prevented by the screen logic (that is upon users attempt), which reduces the total possible number of combinations.

As an example, stratification of responses in the Lethality Domain, labeled “L”, generates scores labeled “L4”, “L3”, “L2”, and “L1”, with L4 being those with the most severe clinical presentation and risk, and L1 being those with the mildest symptoms and risk. Stratification is performed across the first five domains as follows:
Domain 1, Symptom Severity or “S” is stratified as S4, S3, S2 and S1, with S4 as the most severe and S1 as the least severe.
Domain 2, Lethality or “L” is stratified as L4, L3, L2 and L1, with L4 as the most severe and L1 as the least severe.
Domain 3, Psychosocial or “P” is stratified as P4, P3, P2 and P1, with P4 as the most severe and P1 as the least severe.
Domain 4, Functional Impairment or “F” is stratified as F4, F3, F2, and F1, with F4 as the most severe and F1 as the least severe.
Domain 5, Medical Conditions or “M” is stratified as M4, M3, M2, and M1, with M4 as the most severe and M1 as the least severe.

In this example, Domains 6 and 7, Patient Resources and Provider Resources, respectively, are not stratified, however, may be stratified upon the need, as described above.

Examples of criteria used to map responses in each domain to the stratification levels are presented in Appendix A in a table format, the entire contents of which are hereby expressly incorporated by reference. The criteria presented in Appendix A are the “anchor” criteria, representing the clearest examples of the response sets for each stratification level. Because users can enter many other combinations of responses, including leaving items unanswered, a set of “gap” equations (criteria) is created to account for all combinations of input responses (excluding those prevented by the screen logic). Each gap equation is mapped to a stratification level based on the degree to which it deviated from its nearest anchor criteria.

A fourth level of logic joins the domain severity levels across the seven domains, with some derived variables and input variables, and maps them to the medical necessity criteria related to each LOC.

In some embodiments, some standard behavioral health level of care categories used in the invention include:

Inpatient

Residential Treatment Program

Partial Hospital Program

Intensive Outpatient Program (IOP)

Outpatient Services

In some embodiments, a separate set of LOC decision logic is used for cases having a substance abuse diagnosis, or dual diagnosis with the focus of treatment being substance abuse. In these cases, an additional level of care labeled “SA—Inpatient Medical” is also used. The substance abuse LOC decision logic employs the same methodology as described above, but the criteria for mapping response sets to the levels of care include American Society of Addiction Medicine (ASAM) criteria for substance abuse.

An exemplary criteria used to map the stratified variables across the different domains to levels of care for substance abuse cases are presented in Appendix B, the entire contents of which are hereby expressly incorporated by reference. In some embodiments, all combinations of domain stratification levels and variables (response sets) are mapped to a level of care. As with the gap equations described above, in some cases mapping of response sets to a level of care is based on the distance between the response set and its closest anchor response set, or it was based on clinical community standards.

The level of care decision logic is capable of handling missing data, that is, the logic checks to see how many and which domain pages are left blank. In some embodiments, a minimum threshold of required information was established as follows based on clinical community standards: Users should provide input for at least one item on the Lethality domain (which will provide some indication of the patient's level of risk) plus at least one item on at least one other domain from Symptom Severity, PsychoSocial Support, Functional Impairment, or Medical Conditions. If only this minimum amount of information is provided, it will result in an outpatient level of care. Additional information is required to document the need for a higher level of care. However, if the user does not provide the minimum amount of information, the invention returns a level of care of “Insufficient Input”.

The invention may also generate a recommended level of urgency for each record. This decision process also uses the domain severity levels, derived variables and input variables, and maps combinations of value to the following levels of urgency:

Emergent: services needed emergently

Urgent: services required urgently

Routine: Services that may be rendered in a routine manner and time frame

Examples of criteria used to map the stratified variables across the different domains to levels of care are presented in Appendix C.

The invention generates an output report that includes the recommended (mapped) level for care and level of urgency. The report includes the rationale, which is a narrative of the input variables within each domain, diagnosis, symptoms, and diagnosis verification. Each domain is given (assigned) a numerical score based on the items selected within the domain. The scores are computed by summing the scores for the component item responses within each domain, based on community standards and research as to the clinical relevance and level of severity of each variable and response within the domain.

In some embodiments, the invention also generates a graph of the domain scores as a visual presentation of the patient's clinical profile. The profile enables users to quickly and clearly see the severity of each domain and its relative value compared to the other domains. After the second, third, and subsequent sessions are completed, the profile displays the domain scores from the current and previous two sessions, enabling users to see changes in the scores individually and globally over time. This serves as an outcome measure of treatment response.

Following the graph, the invention report presents the DSM-IV diagnoses on Axes I, II, and III entered by the user in the Symptom Severity domain; the symptoms associated with the primary diagnosis as selected by the user; and the invention determination of whether the diagnosis was verified by the symptoms selected by the user. Clinical logic is embedded in the application to determine if the symptoms selected by the user meet the DSM IV criteria for the diagnosis, or are suggestive of the diagnosis by meeting a certain percentage (for example, 70%) of the criteria, or do not meet the criteria. The logic is based on clinically accepted community standards.

The diagnosis verification feature of the invention enables clinical managers to profile providers as to their diagnostic integrity and accuracy. This is a critical component of the application as effective treatment and evidence-based medicine requires accurate diagnosis.

In some embodiments, the invention includes several Graphical User Interface (GUI) screens for the user to interact with the invention. Although, for simplification and illustration purposes, specific and at time, detail exemplary screens for the GUIs are described below, the invention is not limited to such screens. Other screens/GUIs may be used with the present invention to input the appropriate data and display desired result.

In some embodiments, users access the invention's software application through a web browser on an Internet-enabled computer via a login screen. On the login screen, they enter their user names and passwords. The system verifies that they are registered users, identifies the database on which they are registered, and opens the application to the Patient Manager window, as depicted in FIG. 5A.

A Patient Manager window enables users to search for individual patient records, and enter new patients. When creating a new patient, users first conduct a search for the patient to avoid creating a duplicate record. To do this, users enter the new patient's name and other available information (e.g., phone number, birth date, Social Security Number) into the Search criteria and click on Search. If the patient does not already exist in the database, the system will display a message asking if the user wants to create a new record. If the user clicks “Yes”, the system opens the Add/Edit Patient window, as shown in FIG. 5B, and transfers into it the information used for the search.

To create the new patients, users complete the information in an Add/Edit Patient dialog window and click Save, as depicted on the right side of FIG. 5B. The system returns to the Patient Manager window with the new patient record in focus/highlighted as shown in FIG. 5C.

To create a session for the new patient, users click the link labeled “New” in the patient's record. This opens a record screen, as shown in FIG. 5D. Users record all available clinical information about the patient across the seven domain. In the Symptom Severity domain, users can record up to four Axis I diagnoses and three Axis II diagnoses. Users can also record the patient's symptoms associated with each diagnosis. The invention verifies the diagnosis by indicating whether the symptoms selected meet the DSM-IV CR criteria for the diagnosis. The invention also indicates whether the symptoms are “suggestive of” the diagnosis by meeting a certain threshold, for example, 70% of the necessary DSM criteria, or simply do not meet the criteria for the diagnosis.

This information is valuable for (a) clinical training, (b) case reviews between providers, and (c) avoiding denials from managed care. To record the patient's diagnoses, users click on the link in Item 2 labeled “Select one or more axis I diagnoses”. This link opens the Axis I fields screen, as shown in FIG. 5E. Clicking on the link again closes the fields to reduce the vertical space of the window. A similar link and fields are available to record Axis II diagnoses.

To enter a primary diagnosis, users click on a link labeled “Primary”. This opens a window that displays a DSM-IV diagnoses by category in an expandable tree format, as shown in FIG. 5F. Clicking on a category displays the diagnoses or subcategories beneath it, as shown in FIG. 5G.

Clicking on one of the diagnoses closes the selection window and returns focus to the record with the selected diagnosis displayed in the Primary diagnosis field.

To indicate the symptoms associated with the diagnosis and verify the diagnosis, users click a link labeled “Verify Symptoms”. This opens a Symptom selection window, as shown in FIG. 5H. Users click the check boxes indicating the symptoms and conditions associated with the diagnosis, and then click Submit. This window closes and focus returns to the record. Users then indicate the severity of the diagnosis using the far right drop down box.

I short, in FIG. 5D, question 2 highlights that an Axis I DSM Diagnosis can be selected; FIG. 5E expands the choices, that up to 4 Axis I diagnoses can be selected; FIG. 5F shows the tree view of the diagnoses in “Top Ten Diagnoses”; FIG. 5G depicts the expanded diagnoses tree; and finally FIG. 5H illustrates the Diagnostic criteria and associated Symptoms for a particular selected Diagnosis.

When all available information is recorded for the domain, users click Next at the bottom or top of the page. The system progresses to the next domain, which is shown in the tabs at the top of the page, and by the “Steps Completed” indicator below the tabs and next to the Next button, as shown in FIG. 5I. The next domain is labeled “Lethality” and is displayed in the exemplary screen of FIG. 5I.

The Lethality screen of FIG. 5I is used primarily to record information about danger to self, others, or being gravely disabled. The items capture information about the degree and nature of the patient's risk, and history of behavior. When users complete their data entry on this page, they click the Next button.

The next domain, labeled PsychoSocial Support and shown in FIG. 5J, is used to record information about home or living environment; whether the patient lives alone or with others, whether the environment is a source of stress or can provide safety to the patient.

An exemplary Functional Impairment domain screen is depicted in FIG. 5K. Information recorded here pertains to the patient's ability to perform daily living activities and fulfill role responsibilities. It also asks about sources of stress, such as, relationship, work, financial, legal, children, etc.

An exemplary domain labeled Medical Conditions is shown in FIG. 5L. This domain is used to record co-morbid medical conditions and whether they might exacerbate or be exacerbated by the patient's mental health condition. It also asks about the whether the patient is decompensating and the rate of decompensation.

Each of the five domains presented above generate a severity score that is used in determining level of care and severity, and is presented in the report graph presented later.

The last two domains, labeled Patient Resources and Provider Resources, are used to record information about factors that can ameliorate or exacerbate the patient's condition on each of the previous five domains. Patient Resources domain screen of FIG. 5M focuses on motivation for and compliance with treatment, and possible cognitive deficits that might interfere with treatment.

A Provider Resources domain (shown in FIG. 5N) is used to record information about special services the patient requires for admission to a new level of care or continuation at the same level of care, and whether the patient has received these services in the recent past. It is also used to record basic information about the patient's history of treatment, starting with the most recent treatment and its outcome, to an overview of the patient's entire treatment history and which levels of care met with success or failure.

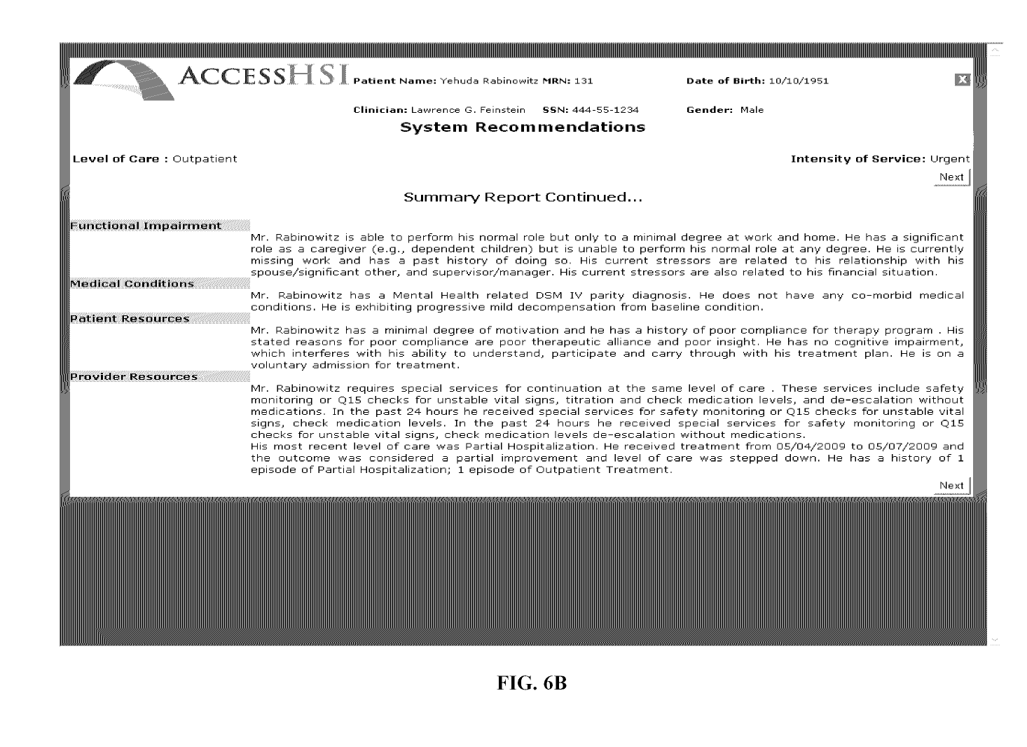

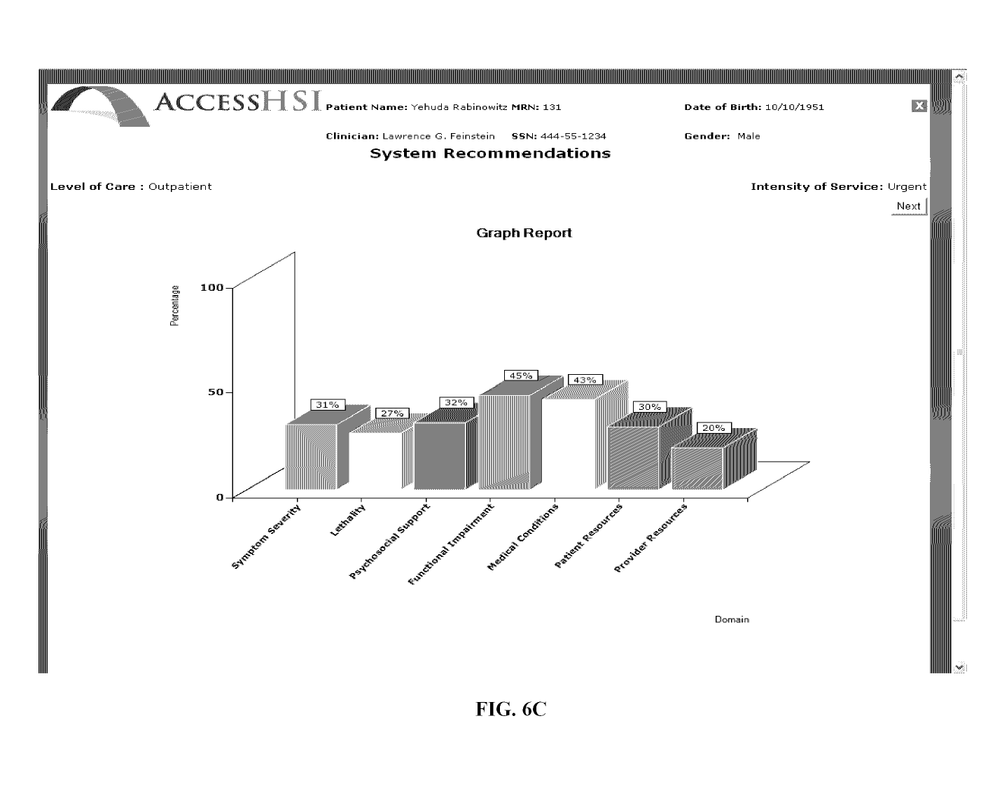

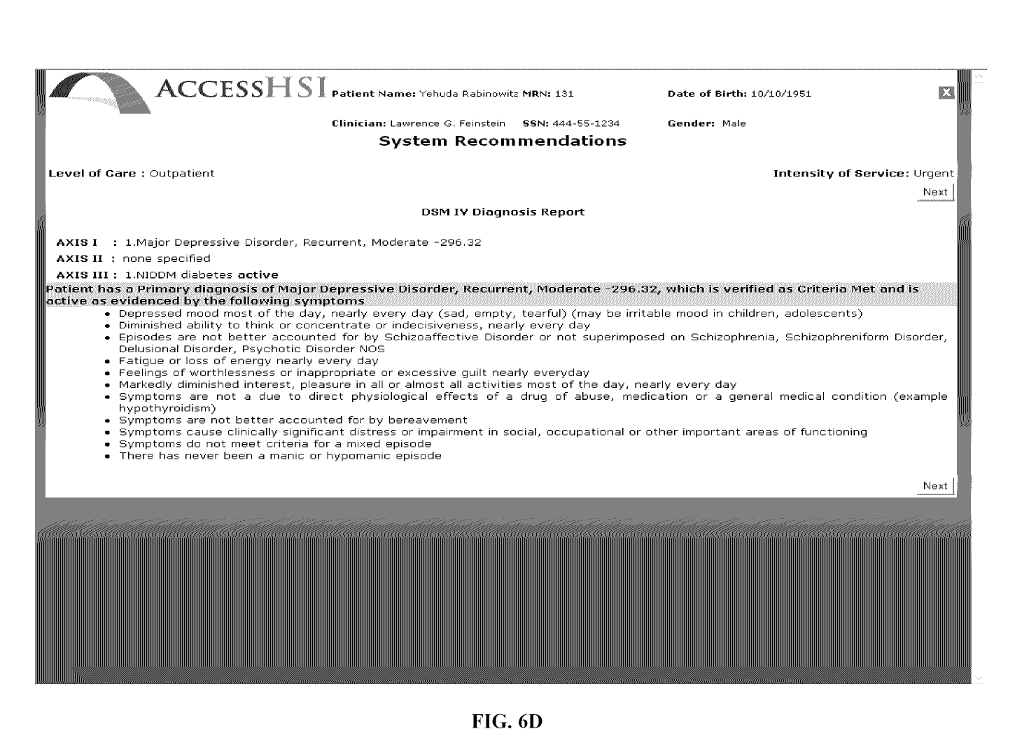

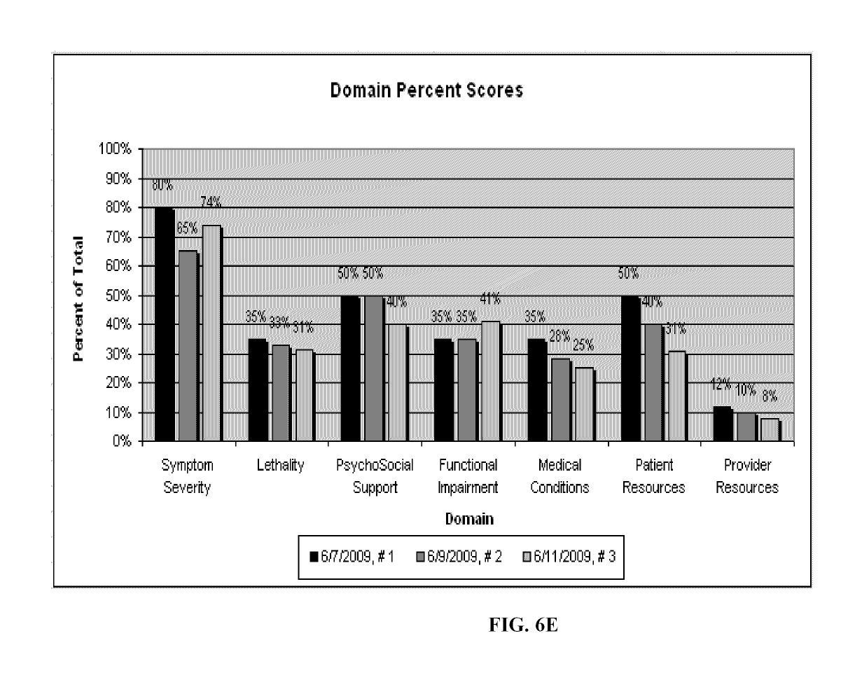

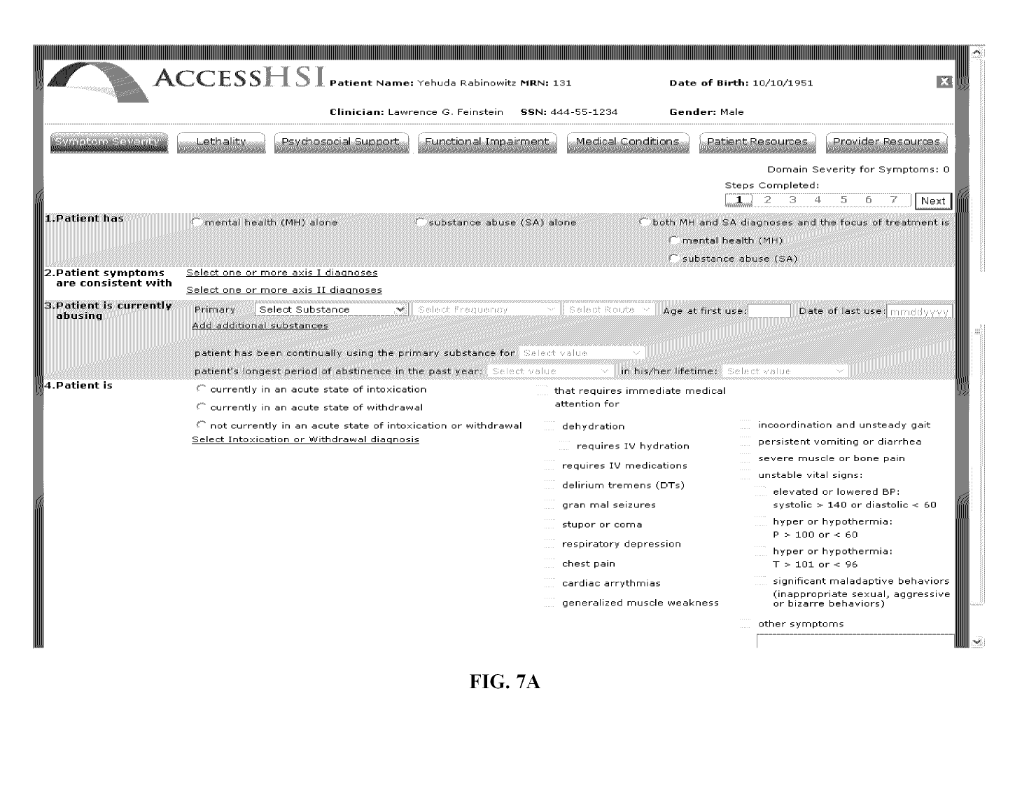

FIGS. 6A-6F show various exemplary reporting screens, according to some embodiments of the present invention. When users complete entering information on the Provider Resources page and click Next, they have completed recording the clinical data for this session. The invention computes scores for each of the domains and generates a suggested “Level of Care” and “Intensity of Service.” The invention then begins displaying a summary report based on the user's input. In some embodiments, the report is presented in four sub-sections, or one complete section, as described below.

The first section of the report is a narrative of the information from the first three domains, as shown in FIG. 6A. The second section of the report is a narrative of the information from the next four domains, as shown in FIG. 6B. The third section is a presentation of the domain scores in graphical format, as shown in FIG. 6C.

The domain score graph of FIG. 6C enables users to quickly understand the global status of the patient's condition across all seven domains, instead of focusing on one or two areas (typically, lethality and symptoms). The graph brings to users' attention information that they may not normally have considered, such as impaired role functionality or co-morbid medical conditions.

The fourth section of the report is a presentation of the DSM-IV diagnoses on Axes I, II, and III; the symptoms associated with the primary diagnosis as selected by the user; and the invention determination of whether the diagnosis was verified by the symptoms selected by the user, as shown in FIG. 6D.

After reviewing each section of the report, users are asked to indicate whether they agree or disagree with the invention-suggested level of care and intensity of service. If they disagree, users can select a level of care and intensity of service and record their rationale.

After submitting their response, upon request, the invention presents the full report, which includes the four sections described above combined.

In some embodiments, at the bottom of the invention report are three buttons, two are used to print or email the report. If a managed care company has licensed the invention and set up online report submission, a fourth button will appear to submit the report to the managed care company by transferring the record to their database. Otherwise, users can submit a report by clicking on the Email button, which will generate, for example, a PDF version of the report and send it to a managed care recipient, or any designated recipient, via encrypted email. Managed care companies can configure their systems to respond to report submissions by automatically authorizing care when the user accepts the suggested level of care (LOC), which matches the managed care company's own LOC guidelines, and transfer to care managers only those cases where users disagree with the suggested LOC.

Users at a hospital, facility or large provider group who have an electronic medical record (EMR) system can transfer an invention report into a patient's EMR if this feature has been configured by the hospital, facility or group. In this case, data mapping will be set up to enable the invention system to link to matched patient records in the EMR system, and data fields will be mapped to receive some or all of the invention data and an image of the entire report.

The users can print the invention report. After users have completed their review and print out of the report, the application returns focus to the Patient Manager where users can enter another new patient or search for an existing patient to begin a second, third, or subsequent session or complete an existing incomplete session.

For most inpatient cases, users will need to create a follow-up session within 2 days to report a patient's progress to managed care and to request continued authorization. Users in hospital settings may also need to provide follow-up reports every second or third day for several days until the patient is discharged. For most outpatient cases, and cases at intermediate levels of care, a second or third session may also be required. The invention provides a method to create a 2^{nd}, 3^{rd} or subsequent invention session in an extremely rapid manner. Returning to the Patient Manager, users search for and locate the existing patient. Clicking on the link labeled “New” in any of the patient's records (there may be several if more than one session has already been completed) will begin the process to create the next record for the patient.

When the record screen opens, all data from the previous session is displayed and all the fields are editable allowing the user to edit any value. (This is in contrast to viewing a previous record, by clicking on a link in the “View Assessment” column in the Patient Manager, where the data is visible but all the fields are locked preventing the data from being modified.)

In addition, in the subsequent session, values selected in the previous session are highlighted using circles around radio buttons and squares around check boxes. Items that are changes are then highlighted by underlining the stem of the question. This technique enables users to rapidly see the items they have changed, and the previous values in those items should they wish to revert to the previous value or simply compare the new value to the old value. Thus, when creating a subsequent session, users need only change those items that reflect changes in the patient's status.

After recording data in each of the domains, the invention generates a new report reflecting the information in the subsequent session, including the new information. The invention also generates a graph of the domain scores, and includes in the graph the scores from the current session and the previous, for example, two sessions. Thus, the second session will display scores from sessions 1 and 2; the third session will display scores from sessions 1, 2, and 3; the fourth session will display scores from sessions 2, 3, and 4, and so on. FIG. 6E shows a sample of a graph from a third session, displaying scores from sessions 1, 2, and 3.

Showing scores from the current session and the previous two sessions enables users and reviewers to quickly identify trends in the data that reflect important and perhaps unnoticed changes in the patient's status. For example, while clinicians and case management reviewer often focus on a patient's status in critical domains such as Symptom Severity or Lethality, the graph enables them to see that significant changes in other domains such as Patient Resources or Medical Conditions are likely to contribute to a re-admission or relapse.

In some embodiments, the software of the present invention is implemented using .Net Framework™ and Visual Studio™. ASP.NET MVC™ Framework is a Model-view-controller framework which allows software developers to build a Web application as a composition of three roles: Model, View and Controller. A Model represents the state of a particular aspect of the application. Frequently, a model maps to a database table with the entries in the table representing the state of the table. A Controller handles interactions and updates the model to reflect a change in state of the application. A View extracts necessary information from a model and renders a user interface to display that.

The ASP.NET MVC™ Framework couples the models, views and controllers using interface-based contracts, thereby allowing each component to be easily tested independently. The view engine in the MVC™ framework uses regular .aspx pages to design the layout of the user interface pages onto which the data is composed. However, any interactions are routed to the controllers rather than using the post back mechanism. The software of the present invention may be executed on a client computer, a stand-alone computer and/or a server computer aceesible to the users through the Internet.

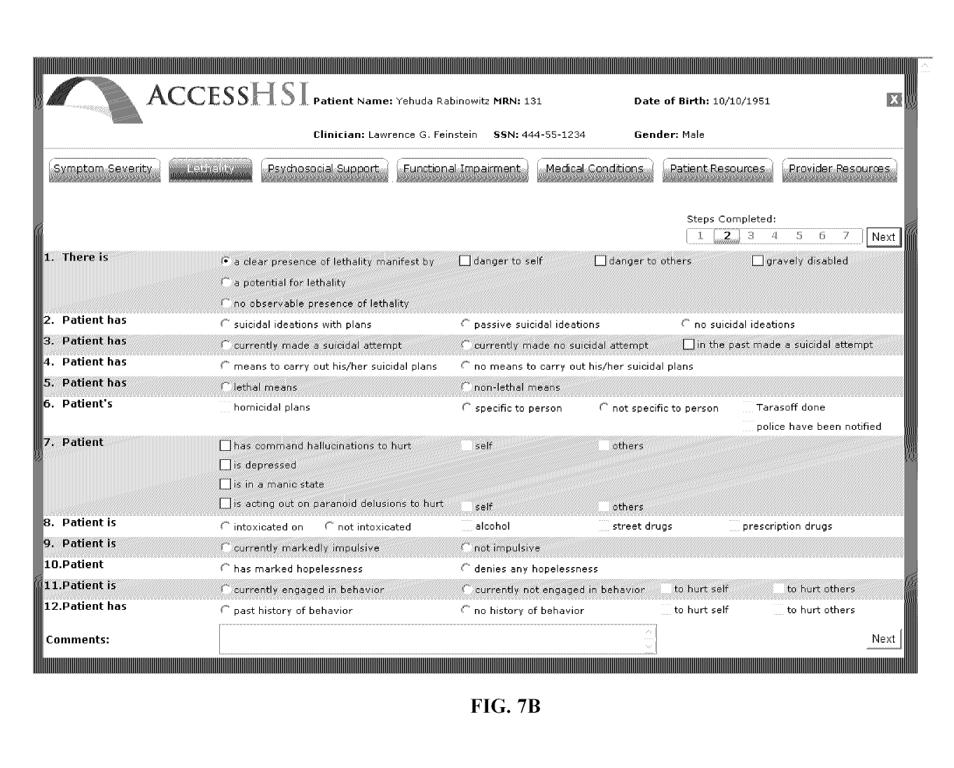

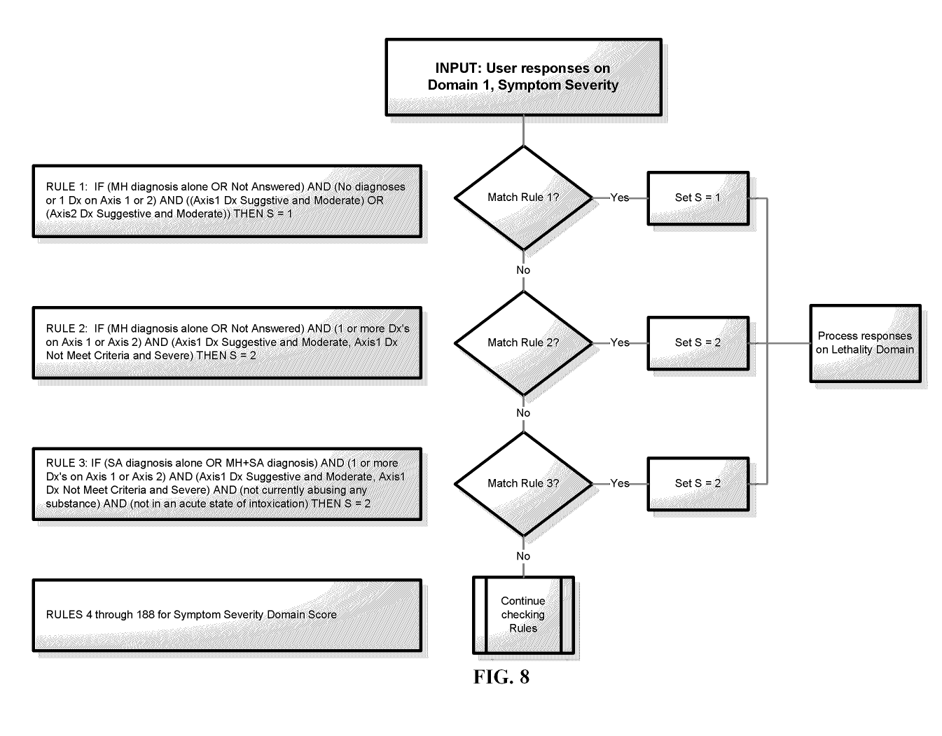

FIGS. 7A and 7B illustrate an abbreviated example of how the four levels of rules work together to generate a recommended Level of Care based on the user's input, according to some embodiments of the present invention.

In a first domain, Symptom Severity, the user indicates in item 1 that the patient has a mental health diagnosis, as depicted in FIG. 7A. In item 2, the user indicates that the patient has a single Axis 1 diagnosis, for example, Major Depression, Recurrent, Moderate. The user opens the symptom check list and selects a number of symptoms. When the check list is closed, the invention's diagnosis verification process indicates that the symptoms are “Suggestive” of the diagnosis. The user selects Moderate as the level of severity for the diagnosis.

As shown in FIG. 7B, based on the Symptom Severity domain scoring rules, a score of “S2” (third highest of four levels) is generated. The use then clicks on the Next button at the bottom of the screen to proceed to the Lethality page. On the Lethality page, the user indicates on item 1 that the patient has a clear presence of lethality manifested by danger to self.

On items 2, 3, 4, and 5, the user indicates that the patient has suicidal ideations with plans, currently made no suicidal attempt, but has means to carry out his suicidal plans and has lethal means to do so. On items 7, 8, 9, and 10, the user indicates that the patient is depressed, is not intoxicated, is currently markedly impulsive, and has marked hopelessness.

On items 11 and 12, the user indicates that the patient is currently not engaged in behavior to hurt himself but has a past history of hurting himself. When the user clicks Next to send this information to the server, the system first calculates several derived variables. The response to item 10 generates a variable labeled “Hopelessness” equal to 1. The responses to item 7 generate a variable labeled “Symptom” equal to 1. The responses to items 8 and 9 generate a variable labeled “Alcohol_Impulsive” equal to 1. A variable labeled “Factor4” is generated by summing the values of Hopelessness, Symptom, and Alcohol_Impulsive.

Next, a Lethality domain scoring process uses items 1 through 5 and Factor4 to generate a score of “L4” (highest of four levels). On the third domain, labeled “PsychoSocial Support”, the user indicates on the 6^{th} item that the patient's home environment does not have the capability to provide safety if the patient exhibits behavior that is harmful to him/herself or others, or abuses alcohol or drugs. When the user completes all seven domains, the decision processes use the domain scores, derived variables, and raw variables to compute a recommended Level of Care. In the current example, the high lethality score of L4 in combination with the response to item 6 on the PsychoSocial Support domain generates a recommended Level of Care of “Inpatient”. In this particular case, the S2 domain score did not play a role in determining the recommended level of care because the combination of L4 and PsychoSocial item 6 were sufficient to match one of the decision rules. However, if Lethality were not L4, then the combination of S2 and PsychoSocial item 6 (plus other variables) would result in a level of care of Residential Treatment.

FIGS. 8, 9 and 10 illustrate an exemplary process by which the domain scoring process generates derived variables and domain scores, and then the level of care processes use this input to generate a recommended level of care is displayed in the following three flow diagrams. In each diagram, a decision processes compares the user's input to a series of carefully crafted and organized rules until a match is found. Each rule is composed of a different set of criteria reflecting specific clinical criteria.

FIG. 8 shows an exemplary process flow, implemented by a computer, for comparing a user's input to a series of rules to generate the Symptom Severity domain score, according to some embodiments of the present invention. As shown in the example of FIG. 8, the domain score (S4, S3, S2, or S1) is derived from the total configuration of item responses in the domain. While in general a higher score will result from greater pathology across items, there are also interactions between moderator items that may result in a lower score; for example, the contribution of a severe diagnosis will be moderated if it is not verified.

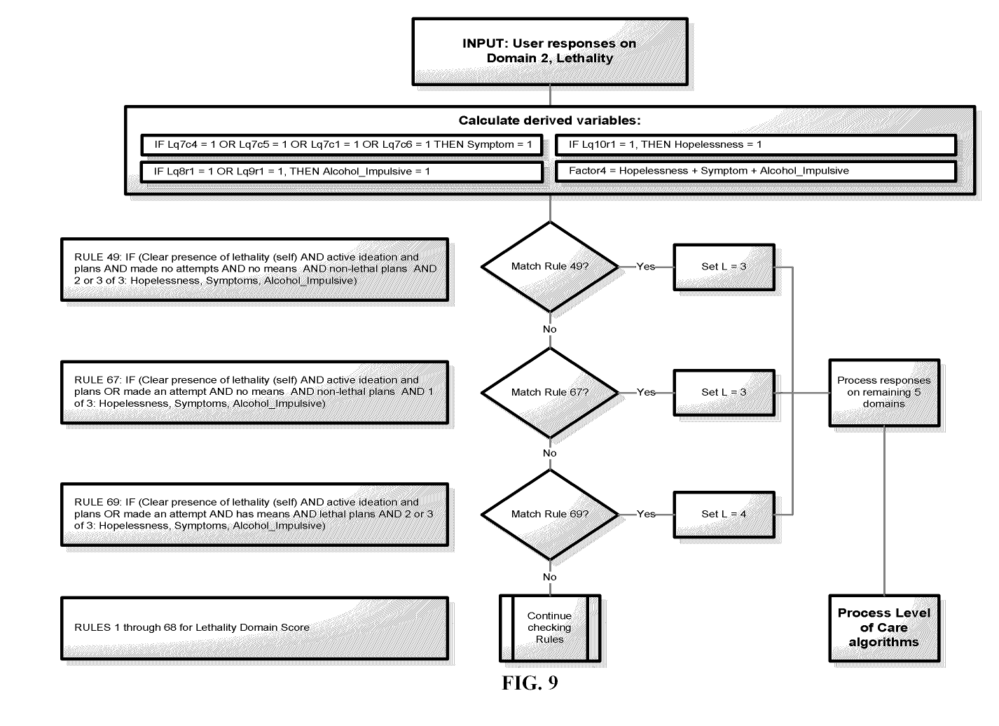

FIG. 9 shows an exemplary process flow, implemented by a computer, for utilizing a user's input to compute derived variables, and then compared to a series of rules to generate the Lethality domain score, according to some embodiments of the present invention. As depicted, after derived variables and domain stratification scores are computed for each domain, the program then invokes another series of rules to determine the Level of Care.

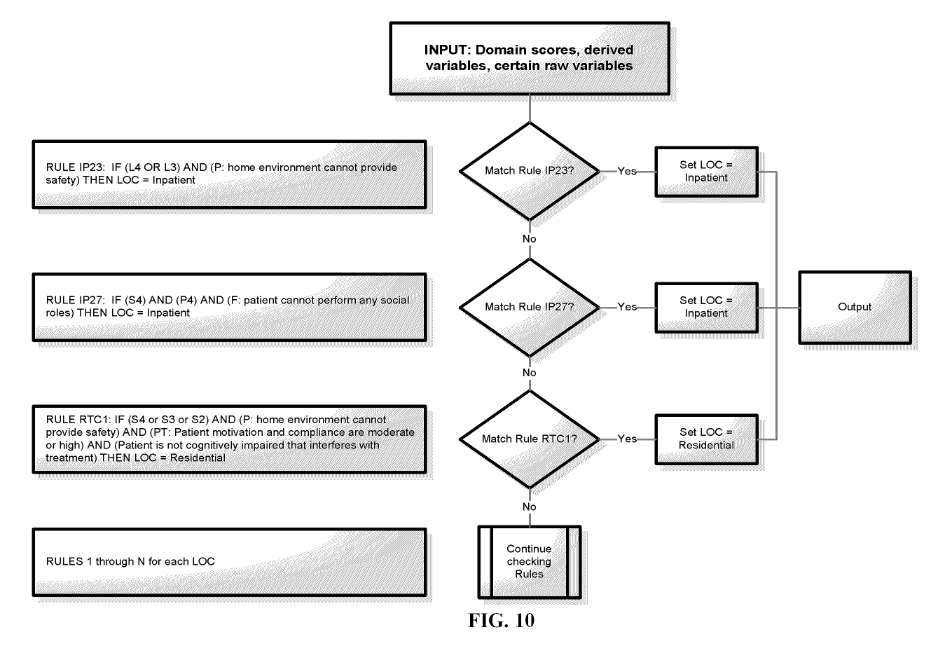

FIG. 10 illustrates an exemplary process flow, implemented by a computer, for utilizing derived variables and domain scores as input to compute and generate a Level of Care, according to some embodiments of the present invention. In this exemplary figure, each level of care is “represented” by a series of process and decision making rules. Each combination of domain scores, items scores, and derived variables resulting from the user's input is compared to the rules for each level of care. The rules are designed to assess the total configuration or “clinical picture” of scores and variables; the rules are not mathematical equations that sum the scores. Seemingly similar combinations of domain scores and items generate different level of care results when one or two key variables differ, as shown in FIG. 10. Furthermore, a domain score of S4 contributes to a level of care of Inpatient in rule IP27 when it appears in combination with P4, high risk home environment on the PsychoSocial Support domain, and severe deficiencies in ability to perform social roles on the Functional Impairment domain. However, when P4 is not present, the same S4 will contribute to contribute to a level of care of Residential Treatment in rule RTC1 when it appears in combination with other specific variables that match the clinical criteria for Residential Treatment. Moreover, when L4 is present in combination with Pq6r1 (PsychoSocial question 6 response 1: the patient's home environment cannot provide safety), that combination alone is sufficient to generate an inpatient level of care result without even considering the S4 score.

In some embodiments, the invention includes five major functional modules: a Login module, an Agency module, an User module, a Patient module, and an assessment module. In some embodiments, “Use Case” documents are used for each module

The Login module holds the authentication information for the application, verifies the user credentials and allows the user to access the application, according to some embodiments of the present invention.

The Agency module holds information of the agency record created in the application agency details like agency name, contact information and login id and password, according to some embodiments of the present invention.

In some embodiments, the User module includes two pages: in its start page, a search page has search option for finding the saved record in the grid and user can click the user record in the grid to edit the existing record, and second page is to create new user. This page gets the details of the user like the contact details, educational details, Security level, user roles played by each user and users photograph.

In some embodiments, the Patient module includes two pages; in it start page is a search page which includes search option for finding the saved patient record in grid and user can click the patient record in the grid to edit the existing record and second page is to create new patient. This page gets the details of the patient like the contact details, Insurance details, etc.

In some embodiments, the Assessment module includes seven domains. Each domain carries set of question and answers. This module is attached to the patient search page along with grid. The user can click the new assessment link to start assessment for the particular patient. The seven exemplary domains are namely:

Symptom Severity

Lethality

Psychosocial Support

Functional Impairment

Medical Condition

Patient Resources

Provider Resources

Each domain has a domain score calculated based on the answer selected in each domain. The scores obtained in each domain are consolidated to prepare the level of care that is needed for the patient. Level of care logic and domain score logic are populated in a database to choose the scenario according the answers given, and generate the level of care for the patient. The user can accept the systems level of care or can deny and save his/her own level of care for the patient.

In some embodiments, Assessment Module Screens are dynamically generated from database values populated in a table (MST_QUESTION table), which stores the question of each domain. A (MST_ANSWER) table stores the answers to each question domain wise. A (IMP_ANSWER) table stores impacted answer values, based on the answers chosen, and a (TRN_ASSESMENT) table stores the values for each domain chosen by the user.

In some embodiments, Symptom Severity domain has two sub pages for its second question answer, one is for choosing the diagnosis and the other is its classification page. Classification answers are populated based on the diagnosis selected by the user. The Diagnosis page uses a (MST_AXIS DIAGNOSIS) table for populating the diagnosis tree view structure and based on the diagnosis chosen by the user, classification page is populated from a (MST_AXIS_CLASS_GROUP) table which holds the question of the classification page. A (MST_AXIS_CLASSIFICATION) table stores the classification answers for the page and a (TRN_AXIS_CLASSIFICATION) table uses the two table values and joins the question and answer for each diagnosis. Answers chosen by the user in the classification page are also saved under another (TRN_ASSESSMENT) table. The tables' structures and variable are shown in detail in the Provisional application, the entire contents of which is already expressly incorporated by reference.

Appendix A explains the domain stratification logic and its related domains in more detail. Appendix B explains the domain stratification logic for substance abuse cases, as an example. Appendix C describes exemplary Level of Care Criteria.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

### Appendix A

### Domain Stratification Logic

### Symptom Severity Domain

### S4

| | | |
|---|---|---|
| | 1.Patient has two or more diagnoses with: | yes/no |
| | a) Axis I | |
| | a1) only MH OR | |
| | a2) only SA OR MH+SA | |
| and | b) Axis I + Axis II diagnosis | yes/no |
| | symptoms meets “criteria met” for at least one of the diagnoses and at least “suggestive ” for other(s) | |
| and | symptoms are severe for at least one of the diagnoses with status = Criteria Met or Suggestive | yes/no |

and IF patient has an SA diagnosis (applies to all remaining criteria) ...

| | |
|---|---|
| | 2. Patient is currently using (abusing) alcohol, street drugs, or prescription |
| | drugs |
| and | |
| ITEM 4: | 3. Patient is in an acute state of intoxication or withdrawal meets “Criteria met” or “Suggest” |
| | requiring immediate medical attention in a medical facility or IP facility |
| | 1 or more symptoms in column 1 OR |
| | 2 or more symptoms in column 2 |

### S3

| | | |
|---|---|---|
| | 1.Patient has one or more diagnoses with: | yes/no |
| | a) Axis I | |
| | a1) only MH OR | |
| | a2) only SA OR MH+SA | |
| | b) Axis II diagnosis | |
| and | symptoms meets “criteria met” for at least one of the diagnoses | yes/no |
| and | symptoms are moderate for at least one of the diagnoses with status = Criteria Met | yes/no |

and IF patient has an SA diagnosis (applies to ail remaining criteria) ...

| | |
|---|---|
| | 2. Patient is currently using (abusing) alcohol, street drugs, or prescription |
| | drugs |
| and | |
| ITEM 4: | 3. Patient is in an acute state of intoxication or withdrawal meets “Criteria met” or “Suggest” |
| | no symptoms checked in column 1 AND |
| | 1 or more symptoms in column 2 |
| | OR the patient is not in an acute state of intoxication or withdrawal |

### S2

| | | |
|---|---|---|
| | 1.Patient has one or more diagnoses with: | yes/no |
| | a) Axis I | |
| | a1) only MH OR | |
| | a2) only SA OR MH+SA | |
| | b) Axis II diagnosis | |
| and | symptoms meets “suggestive” for at least one of the diagnoses | yes/no |
| and | symptoms are moderate for at least one of the diagnoses with status = Suggestive | yes/no |
| | SuggestModerate OR NotMeetSevere | |

and IF patient has an SA diagnosis (applies to all remaining criteria) ...

| | 2. Patient is currently using (abusing) alcohol, street drugs, or prescription |
|---|---|
| | drugs |
| and | |
| ITEM 4: | 3. Patient is in an acute state of intoxication or withdrawal meets Meet, Suggest, Not Meet or Not Verified |
| | no symptoms checked in column 1 AND |
| | 1 or more symptoms in column 2 |
| | OR the patient is not in an acute state of intoxication or withdrawal |

### S1

| | | |
|---|---|---|
| | 1.Patient has one or no diagnoses with: | yes/no |
| | a) Axis I | |
| | a1) only MH OR | |
| | a2) only SA OR MH+SA | |
| | b) Axis II diagnosis | |
| and | symptoms meets “meet”, “suggest” or “not meet” for the diagnosis (any status value) | yes/no |
| and | symptoms are moderate or mild for the diagnosis with status = Suggestive or Does Not Meet | yes/no |

and IF patient has an SA diagnosis (applies to all remaining criteria) ...

| | | |
|---|---|---|
| | 2. Patient is not currently using (abusing) alcohol, street drugs, or prescription | |
| | drugs | |
| and | | |
| | 3. Patient is not in an acute state of intoxication or withdrawal | yes/no |

### Lethality Domain

### L4

| | | |
|---|---|---|
| | There is a clear presence of lethality: | |
| | Danger to self | yes/no |
| or | Danger to others | yes/no |

as determined by:

| | 1. Patient has active suicidal/homicidal plans | | yes/no |
|---|---|---|---|
| or | made a suicide attempt | | |
| and | 2. Patient has available means to carry out | | yes/no |
| | plans/attempts (suicide only) | | |
| and | 3. Plans are lethal (suicide only) | | yes/no |
| | OR Homicidal plans are specific | | |
| and | 4. Patient has any 2 of 3 or all 3 | | |
| | | i) Marked hopelessness | yes/no |
| | and | ii)Depression OR Manic excitement | yes/no |
| | | OR Command hallucinations OR paranoid | |
| | | delusions | |
| | and | iii)Presence of alcohol/drug use | yes/no |

| | |
|---|---|
| OR History of alcohol/drug use | yes/no |
| OR Presence of marked impulsivity | yes/no |
| OR History of impulsivity | yes/no |

### L3

| | There is a clear presence of, or potential for, | | |
|---|---|---|---|
| | lethality: | | |
| | Danger to self | | yes/no |
| or | Danger to others | | yes/no |
| as determined by: | | | |
| | 1. Patient has active suicidal/homicidal plans | | yes/no |
| and | no suicide attempts | | |
| and | 2. Patient has no available means to carry out | | yes/no |
| | plans/attempts | | |
| and | 3. Plans are non-lethal | | yes/no |
| | OR Homicidal plans are non-specific | | |
| and | 4. Patient has any 2 of 3 or all 3 | | |
| | | i) Marked hopelessness | yes/no |
| | or | ii) Depression or Manic excitement | yes/no |
| | | or Command hallucinations or paranoid | |
| | | delusions | |
| | or | iii) Presence of alcohol/drug use | yes/no |

| | |
|---|---|
| OR History of alcohol/drug use | yes/no |
| OR Presence of marked impulsivity | yes/no |
| OR History of impulsivity | yes/no |

### L2

| | | |
|---|---|---|
| | There is a potential for lethality: | |
| | Danger to self | yes/no |
| or | Danger to others | yes/no |

as determined by:

| | 1. Patient has only passive suicidal/homicidal | | yes/no |
|---|---|---|---|
| | ideations. | | |
| and | no suicidal attempts | | |
| and | 2. Patient has no available means to carry out | | yes/no |
| | plans/attempts | | |
| | This criterion is inconsistent with “passive ideation” | | |
| | and will not be included | | |
| and | 3. Plans are non-lethal | | yes/no |
| | This criterion is inconsistent with “passive ideation” | | |
| | and will not be included | | |
| | OR homicidal non-specific plans | | |
| and | 4. Patient has ONLY 1 of 3 | | |
| | | i) Marked hopelessness | yes/no |
| | or | ii)Depression or Manic excitement | yes/no |
| | | or Command hallucinations or | |
| | | paranoid delusions | |
| | or | iii)Presence of alcohol/drug use | yes/no |

| | |
|---|---|
| OR History of alcohol/drug use | yes/no |
| OR Presence of marked | yes/no |
| impulsivity | |
| OR History of impulsivity | yes/no |

### L1

| | | |
|---|---|---|
| | There is no presence of lethality: | |
| | Danger to self | yes/no |
| or | Danger to others | yes/no |

as determined by:

| | | |
|---|---|---|
| | 1. Patient denies any suicidal/homicidal ideations/plans | yes/no |
| | no hopelessness | |
| and | 2. IF Patient has Depression or Manic Excitement | yes/no |
| | or Command hallucinations or paranoid delusions, | |
| | there is : | |
| | i) No intoxicated on alcohol, street drugs, prescription | yes/no |
| | drugs | |
| and | ii) No history of marked impulsivity | yes/no |
| and | iii)Not currently engaging in behavior to harm self or | yes/no |
| | others | |
| | OR in a supportive environment that has the ability | |
| | to carry out a containment plan if such behavior | |
| | should occur. | |

### PsychoSocial Support Domain

### P4

| | 1. Patient's symptoms are exacerbated by or are a direct | yes/no |
|---|---|---|
| | result of interpersonal conflicts in the home. | |
| and | 2. The home is a high risk environment due to: | |
| 1 or more: | | |
| | i) Availability/use of alcohol/drugs | yes/no |
| | or | |
| | ii) History of violence | yes/no |
| | or | |
| | iii)History of abuse | yes/no |
| | or | |
| | iv)History of neglect | yes/no |
| and | 3. Patient is a victim of physical, emotional, or sexual | |
| | abuse | |
| | or | |
| | 4. the patient is a perpetrator of physical, emotional, or | |
| | sexual abuse | |
| and | 5. If patient is out of control or engages in behavior that | yes/no |
| | is a danger to self or others, there is no ability to provide | |
| | a safe environment or carry out a containment plan for | |
| | imminent danger to self or others; OR patient lives alone | |

### P3

| | 1. Patient's symptoms are exacerbated by or are a direct | yes/no |
|---|---|---|
| | result of interpersonal conflicts in the home. | |
| and | 2. The home is a high risk environment due to: | |
| 1 or more: | | |
| | i) Availability/use of alcohol/drugs | yes/no |
| | or | |
| | ii) History of violence | yes/no |
| | or | |
| | iii)History of abuse | yes/no |
| | or | |
| | iv)History of neglect | yes/no |
| and | 3. Patient is a victim of physical, emotional, or sexual | |
| | abuse | |
| | or | |
| | 4. the patient is a perpetrator of physical, emotional, or | |
| | sexual abuse | |
| and | 5. If patient is out of control or engages in behavior that | yes/no |
| | is a danger to self or others, there is clear ability to | |
| | provide a safe environment or carry out a containment | |
| | plan for imminent danger to self or others | |

### P2

| | 1. Patient's symptoms are exacerbated by or are a direct | yes/no |
|---|---|---|
| | result of interpersonal conflicts in the home. | |
| and | 2. The home is not a high risk environment due to: | |
| ONLY 0 or 1 of 3 | | |
| | i) Availability/use of alcohol/drugs | yes/no |
| | or | |
| | ii) History of violence | yes/no |
| | or | |
| | iii)History of abuse | yes/no |
| | or | |
| | iv)History of neglect | yes/no |
| and | 3. Patient is NOT a victim of physical, emotional, or | |
| | sexual abuse | |
| | and | |
| | 4. the patient is NOT a perpetrator of physical, emotional, or | |
| | sexual abuse | |
| and | 5. If patient is out of control or engages in behavior that | yes/no |
| | is a danger to self or others, there is clear ability to | |
| | provide a safe environment or carry out a containment | |
| | plan for imminent danger to self or others | |

### P1

| | 1. Patient's symptoms are not exacerbated by or are not | yes/no |
|---|---|---|
| | a direct result of interpersonal conflicts in the home. | |
| and | 2. The home is not a high risk environment due to: | |
| ONLY 0 of 3 | | |
| | i) Availability/use of alcohol/drugs | yes/no |
| | or | |
| | ii) History of violence | yes/no |
| | or | |
| | iii)History of abuse | yes/no |
| | or | |
| | iv)History of neglect | yes/no |
| and | 3. Patient is NOT a victim of physical, emotional, or | |
| | sexual abuse | |
| | and | |
| | 4. the patient is NOT a perpetrator of physical, emotional, or | |
| | sexual abuse | |
| and | 3. If patient is out of control or engages in behavior that | yes/no |
| | is a danger to self or others, there is clear ability to | |
| | provide a safe environment or carry out a containment | |
| | plan for imminent danger to self or others | |

### Functional Impairment Domain

### F4

| | | |
|---|---|---|
| | 1. Patient is unable to perform his/her normal role, to any | yes/no |
| | degree, at home, work, school or social setting. | |
| and | | |
| | 2. i) Patient has a significant role | yes/no |
| | as care giver | |
| | or care taker | |
| | and | |
| | is unable to perform these duties to any degree | yes/no |
| and | 3. Patient is currently missing work or school | |
| | or | |
| | 4. Patient is currently on work disability or worker's | |
| | compensation | |
| | or | |
| | 5. Patient is currently failing in school or is suspended | |
| | from school | |
| AND | | |
| | 3 or 4 current stressors | |

### F3

| | | |
|---|---|---|
| | 1. Patient is unable to perform his/her normal role only to | yes/no |
| | a minimal degree at home, work, school or social setting | |
| and | | |
| | 2. i) Patient has a significant role | yes/no |
| | as care giver | |
| | or care taker | |
| | and | |
| | is able to perform these duties only to a minimal degree | yes/no |
| | OR | |
| | Patient does not have a significant role as a care giver or | |
| | care taker | |
| and | | |
| | 3. Patient is currently missing work or school | |
| | or | |
| | 4. Patient is currently on work disability or worker's | |
| | compensation | |
| | or | |
| | 5. Patient is currently failing in school or is suspended | |
| | from school | |
| AND | | |
| | 3 or 4 current stressors | |

### F2

| | 1. Patient is only able to perform his/her normal role | yes/no |
|---|---|---|
| | at home or work or school or social setting to a moderate | |
| | degree | |
| | or | |
| | Patient is unable to perform his/her normal role | |
| | at home or work or school or social setting to a expected | |
| | (satisfactory) degree | |
| and | | |
| | 2. i) Patient has a significant role | yes/no |
| | as care giver | |
| | or care taker | |
| | and | |
| | is able to perform these duties, only to a moderate degree | yes/no |
| | OR | |
| | Patient does not have a significant role as a care giver or | |
| | care taker | |
| and | | |
| | 3. Patient has a past history of missing work or school | |
| | or | |
| | 4. Patient has a past history of being on work disability or worker's | |
| | compensation | |
| | or | |
| | 5. Patient is currently failing in school | |

### F1

| | 1. Patient is only able to perform his/her normal role | yes/no |
|---|---|---|
| | at home or work or school or social setting to a | |
| | satisfactory degree | |
| and | | |
| | 2. i) Patient has a significant role | yes/no |
| | as care giver | |
| | or care taker | |
| | and | |
| | is able to perform these duties, only to a satisfactory | yes/no |
| | degree | |
| | OR | |
| | Patient does not have a significant role as a care giver or | |
| | care taker | |
| and | | |
| | 3. Patient has a past history of missing work or school | |
| | or | |
| | no history of missinng school and no history of missing | |
| | work | |
| | or | |
| | 4. Patient has a past history of being on work disability or worker's | |
| | compensation | |
| | no history of disability AND no history of work comp | |
| | or | |
| | 5. Patient is currently maintaining passing grades in | |
| | school | |

### Medical Conditions Domain

### M4

| | | |
|---|---|---|
| | 1. Patient has a major Parity mental health or Substance | yes/no |
| | related DSM-IV diagnosis | |
| and | 2. comorbid (one or more) medical condition(s) that | |
| | is/are poorly controlled | |
| and | 3. i) Patient has marked decompensation from his/her | yes/no |
| | baseline MH status and continues to deteriorate at a | |
| | markedly rapid rate. | |
| or | ii)Patient with history of previous episode of marked | yes/no |
| | rapid decompensation of the MH condition if not | |
| | treated emergently | |

### M3

| | | |
|---|---|---|
| | 1. Patient has a major Parity mental health or Substance | yes/no |
| | related DSM-IV diagnosis | |
| and | 2. comorbid (one or more) medical condition(s) that | |
| | is/are moderately well controlled | |
| and | 3. Patient has marked decompensation from his/her | yes/no |
| | baseline MH status and continues to deteriorate at a | |
| | rate that may require a higher level of care if not | |
| | treated emergently. | |

### M2

| | | |
|---|---|---|
| | 1. Patient has a major Parity mental health or Substance | yes/no |
| | related DSM-IV diagnosis | |
| and | 2. comorbid (one or more) medical condition(s) that | |
| | is/are stable but the stability of the medical condition(s) | |
| | may be adversely affected by significant delay in MH | |
| | treatment | |
| and | 3. Patient has moderate decompensation from his/her | yes/no |
| | baseline MH/SA condition and continues to progressively | |
| | deteriorate without more intensive treatment | |

### M1

| | 1. Patient has a major Parity mental health or Substance | yes/no |
|---|---|---|
| | related DSM-IV diagnosis | |
| | OR minor non-Parity MH or SA related DSM-IV | |
| | diagnosis | |
| and | 2. comorbid (one or more) medical condition(s) that | |
| | is/are stable and chronic are not and would not be | |
| | adversely affected by the MH/SA treatment | |
| | OR no follow up answer regarding effect of delay on | |
| | treatment | |
| and | 3. Patient has progressive (mild) decompensation from | yes/no |
| | his/her baseline MH/SA condition | |
| | OR symptoms that are improving toward his/her baseline | |
| | MH/SA condition | |
| | OR reached his/her baseline condition | |

### Appendix B

### Domain Stratification Logic for Substance Abuse Cases

| Do- | Ques- | | | IP | | | | | |
|---|---|---|---|---|---|---|---|---|---|
| main | tion | Condition | CODE | (Med) | IP | PH | RTC | IOP | OP |
| S | Q2 | SA diagnosis (Select severity level - drop down | Sq2severity1 = 1 or Sq2severity1 = 2 | ◯ | ◯ | ◯ | ◯ | ◯ | |
| | | list) (Severe or Moderate) [use Axis 1 Dx 1 as | or Sq2severity1 = 4 or Sq2severity1 = 5 | | | | | | |
| | | primiary SA Dx] | | | | | | | |
| | | OR | | | | | | | |
| | | SA diagnosis (Select severity level - drop down | Sq2severity1 = 3 or Sq2severity1 = 6 | | | | | ◯ | ◯ |
| | | list) (mild) | | | | | | | |
| | AND | | | | | | | | |
| | Q4 | R1 (currently in acute state of intoxication) or | Sq4r1 = 1 or Sq4r2 = 1 | ◯ | ◯ | ◯ | ◯ | ◯ | |
| | | R2 (currently in acute state of withdrawal) that | | | | | | | |
| | | AND | | | | | | | |
| | | CB requires immediate medical attention for | Sq4c1 = 1 | ◯ | ◯ | ◯ | ◯ | ◯ | |
| | | AND | | | | | | | |
| | | CB (at least 1Sx in column 1) OR | Sq4Medical_Unit_symptoms > 0 | ◯ | | | | | |
| | | CB (none in column 1 and at least 2Sxs in | Sq4Medical_Unit_symptoms = 0 and | | ◯ | | | | |
| | | column 2) OR | Sq4IP_Psych_symptoms > 1 | | | | | | |
| | | CB (none in column 1, 1 in column 2, and | Sq4Medical_Unit_symptoms = 0 and | | | ◯ | | | |
| | | “Other” Sxs of intoxication or withdrawal OR | Sq4IP_Psych_symptoms = 1 and Sq4c12 = 1 | | | | | | |
| | | CB (none in column 1 or 2) and “Other” Sxs of | Sq4Medical_Unit_symptoms = 0 and | | | | ◯ | ◯ | |
| | | intoxication or withdrawal | Sq4IP_Psych_symptoms = 0 and Sq4c12 = 1 | | | | | | |
| | AND | | | | | | | | |
| P | Q5 | R1 OR R2 | Pq5r1 = 1 or Pq5r2 = 1 | | ◯ | | ◯ | | |
| | | OR | | | | | | | |
| | | R3 OR R4 | Pq5r3 = 1 or Pq5r4 = 1 | | ◯ | ◯ | ◯ | ◯ | ◯ |
| | AND | | | | | | | | |
| | Q6 | R1 OR R3 | Pq6r1 = 1 or Pq6r3 = 1 | | ◯ | | ◯ | | |
| | | OR | | | | | | | |
| | | R2 | Pq6r2 = 1 | | | ◯ | | ◯ | ◯ |
| L | Q1 | R2 (a potential for lethality manifest by 1 or | Lq1r2 = 1 and (Lq1c1 = 1 | | ◯ | ◯ | ◯ | ◯ | ◯ |
| | | more CB1, CB2, CB3) | or Lq1c2 = 1 or Lq1c3 = 1) | | | | | | |
| | AND | | | | | | | | |
| | Q2 | R1(suicidal ideations with plan) | Lq2r1 = 1 | | ◯ | ◯ | ◯ | ◯ | |
| | | OR | | | | | | | |
| | | R2 (passive suicidal ideations) OR R3 (no | Lq2r2 = 1 or Lq2r3 = 1 | | | | | ◯ | ◯ |
| | | suicidal ideations) | | | | | | | |
| | AND | | | | | | | | |
| | Q8 | R1(intoxicated on) (1 or more CB1, CB2, CB3) | Lq8r1 = 1 and (Lq8c1 = 1 | ◯ | ◯ | ◯ | ◯ | ◯ | |
| | | (Same as S Q4 R1) AND | or Lq8c2 = 1 or Lq8c3 = 1) | | | | | | |
| | AND | | | | | | | | |
| S | Q4 | R1(currently in acute state of intoxication) | Sq4r1 = 1 | ◯ | ◯ | ◯ | ◯ | ◯ | |
| | | AND | | | | | | | |
| | | CB requires immediate medical attention for | Sq4c1 = 1 | ◯ | ◯ | ◯ | ◯ | ◯ | |
| | | AND | | | | | | | |
| | | CB (at least 1Sx in column 1) OR | Sq4Medical_Unit_symptoms > 0 | ◯ | | | | | |
| | | CB (none in column 1 and at least 2Sxs in | Sq4Medical_Unit_symptoms = 0 and | | ◯ | | | | |
| | | column 2) OR | Sq4IP_Psych_symptoms > 1 | | | | | | |
| | | CB (none in column 1, 1 in column 2, and | Sq4Medical_Unit_symptoms = 0 and | | | ◯ | | | |
| | | “Other” Sxs of intoxication or withdrawal OR | Sq4IP_Psych_symptoms = 1 and Sq4c12 = 1 | | | | | | |
| | | CB (none in column 1 or 2) and “Other” Sxs of | Sq4Medical_Unit_symptoms = 0 and | | | | ◯ | ◯ | |
| | | intoxication or withdrawal | Sq4IP_Psych_symptoms = 0 and Sq4c12 = 1 | | | | | | |
| | AND | | | | | | | | |
| L | Q11 | R1 (currently engaged in behavior) (1 or more | Lq11r1 = 1 and (Lq11c1 = 1 or Lq11c2 = 1) | | ◯ | ◯ | ◯ | ◯ | ◯ |
| | | CB1, CB2) | | | | | | | |
| | AND | | | | | | | | |
| | Q5 | CB (plans are by) R1 | Lq5c1 = 1 and Lq5r1 = 1 | | ◯ | ◯ | | ◯ | |
| | | OR | | | | | | | |
| | | R2 | Lq5c1 = 1 and Lq5r2 = 1 | | | ◯ | ◯ | ◯ | ◯ |
| | AND | | | | | | | | |
| P | Q5 | R1 OR R2 OR R3 | Pq5r1 = 1 or Pq5r2 = 1 or Pq5r3 = 1 | | ◯ | | ◯ | | |
| | | OR | | | | | | | |
| | | R4 | Pq5r4 = 1 | | ◯ | ◯ | ◯ | ◯ | ◯ |
| | AND | | | | | | | | |
| | Q6 | R1 OR R3 | Pq6r1 = 1 or Pq6r3 = 1 | | ◯ | | ◯ | | |
| | | OR | | | | | | | |
| | | R2 | Pq6r2 = 1 | | | ◯ | | ◯ | ◯ |
| M | Q2 | R1 (one or more comorbid conditions that are | Mq2r6 | | | | | | |
| | | AND | | | | | | | |
| | | R (poorly controlled) AND S Q4 CB requires | Mq2r1 = 1 and Sq4c1 = 1 and | ◯ | | | | | |
| | | immediate medical attention for CB (at least 1 | Sq4Medical_Unit_symptoms > 0 | | | | | | |
| | | Sx in column 1) | | | | | | | |
| | | R (poorly controlled) | Mq2r1 = 1 | | ◯ | | | | |
| | | R (moderately well controlled) | Mq2r2 = 1 | | | ◯ | | | |
| | | R (stable and chronic) | Mq2r3 = 1 | | | | ◯ | ◯ | ◯ |
| | AND | | | | | | | | |
| | Q3 | R1 (marked decompensation/rapid rate) OR R2 | Mq3r1 = 1 or Mq3r2 = 1 | | ◯ | | | | |
| | | (marked decompensation/emergent Tx) | | | | | | | |
| | | OR | | | | | | | |
| | | R3 (moderate decompensation) | Mq3r3 = 1 | | | ◯ | ◯ | ◯ | |
| | | OR | | | | | | | |
| | | R4 (progressive mild decompensatin) | Mq3r4 = 1 | | | | | ◯ | ◯ |
| | AND | | | | | | | | |
| S | Q2 | SA diagnosis (Select severity level - drop down | Sq2severity1 = 1 or Sq2severity1 = 2 or | | ◯ | ◯ | ◯ | ◯ | |
| | | list) (Severe or Moderate) | Sq2severity1 = 4 or Sq2severity1 = 5 | | | | | | |
| | | OR | | | | | | | |
| | | SA diagnosis (Select severity level - drop down | Sq2severity1 = 3 or Sq2severity1 = 6 | | | | | ◯ | ◯ |
| | | list) (Mild) | | | | | | | |
| | AND | | | | | | | | |
| | Q3 | Select Frequency (Daily or 3 to 6 × weekly): | Sq3frequency1 = 1 or Sq3frequency1 = 2 or | | ◯ | ◯ | ◯ | X | |
| | | SELECT HIGHEST Frequence among 4 | Sq3frequency2 = 1 or Sq3frequency2 = 2 or | | | | | | |
| | | substance fields | Sq3frequency3 = 1 or Sq3frequency3 = 2 or | | | | | | |
| | | | Sq3frequency4 = 1 or Sq3frequency4 = 2 | | | | | | |
| | | OR | | | | | | | |
| | | Select Frequency (1 to 2 × weekly) | (Sq3frequency1 = 3 or Sq3frequency2 = 3 or | | | | | X | |
| | | | Sq3frequency3 = 3 or Sq3frequency4 = 3) and | | | | | | |
| | | | (Sq3frequency1 <> 1 and Sq3frequency1 <> | | | | | | |
| | | | 2 and Sq3frequency2 <> 1 and | | | | | | |
| | | | Sq3frequency2 <> 2 and Sq3frequency3 <> | | | | | | |
| | | | 1 and Sq3frequency3 <> 2 and | | | | | | |
| | | | Sq3frequency4 <> 1 and Sq3fre | | | | | | |
| | | OR | | | | | | | |
| | | Select Frequency (1 to 3 × last 30 days) | (Sq3frequency1 = 4 or Sq3frequency2 = 4 or | | | | | X | ◯ |
| | | | Sq3frequency3 = 4 or Sq3frequency4 = 4) and | | | | | | |
| | | | (Sq3frequency1 <> 1 and Sq3frequency1 <> | | | | | | |
| | | | 2 and Sq3frequency1 <> 3 and | | | | | | |
| | | | Sq3frequency2 <> 1 and Sq3frequency2 <> | | | | | | |
| | | | 2 and Sq3frequency2 <> 3 and | | | | | | |
| | | | Sq3frequency3 <> 1 and Sq3fre | | | | | | |
| | AND | | | | | | | | |
| | Q3 | Has been continuously using for - less than 1 | Sq3using_duration = 5 | | | | | ◯ | |
| | | month | | | | | | | |
| | | OR | | | | | | | |
| | | Has been continuously using for - 1-3 month or | (Sq3using_duration >= 1 and | | ◯ | ◯ | ◯ | ◯ | ◯ |
| | | greater or unknown | Sq3using_duration <= 4) | | | | | | |
| | | | or Sq3using_duration = 6 | | | | | | |
| | AND | | | | | | | | |
| | | longest period of abstinence in past year is less | Sq3abstinence_past_year = 1 or | | | | | ◯ | |
| | | than 1 month or 1 to 3 months | Sq3abstinence_past_year = 2 | | | | | | |
| | | longest period of abstinence in past year is 3 to | Sq3abstinence_past_year >= 3 and | | | | | | ◯ |
| | | 6 months or greater or unknown | Sq3abstinence_past_year <= 6 | | | | | | |
| | | longest period of abstinence in lifetime is less | Sq3abstinence_lifetime = 1 | | | | ◯ | | |
| | | than 1 month or 1 to 3 months | or Sq3abstinence_lifetime = 2 | | | | | | |
| | | longest period of abstinence in lifetime is 3 to 6 | Sq3abstinence_lifetime >= 3 and | | | | | ◯ | ◯ |
| | | months or greater or unknown | Sq3abstinence_lifetime <= 6 | | | | | | |
| | AND | | | | | | | | |
| F | Q1 | R1 | Fq1r1 = 1 | | ◯ | | | | |
| | | OR | | | | | | | |
| | | R2 | Fq1r2 = 1 | | | ◯ | ◯ | ◯ | |
| | | OR | | | | | | | |
| | | R3 OR R4 OR R5 | Fq1r3 = 1 or Fq1r4 = 1 or Fq1r5 = 1 | | | | | ◯ | ◯ |
| | AND | | | | | | | | |
| PT | Q1 | R1 OR R2 | PTq1r1 = 1 or PTq1r2 = 1 | | | | | ◯ | ◯ |
| | | OR | | | | | | | |
| | | R3 OR R4 | PTq1r3 = 1 or PTq1r4 = 1 | | | ◯ | ◯ | ◯ | ◯ |
| | AND | | | | | | | | |
| | Q2 | R1 OR R2 | PTq2r1 = 1 or PTq2r2 = 1 | | | | | ◯ | ◯ |
| | | OR | | | | | | | |
| | | R3 OR R4 | PTq2r3 = 1 or PTq2r4 = 1 | | | ◯ | ◯ | ◯ | ◯ |
| | AND | | | | | | | | |
| | Q3 | R1 and R(interferes) any of 2 of 3 CB [2 or | PTq3r1 = 1 and PTq3r5 = 1 and (PTq3c1 + | | ◯ | | ◯ | | |
| | | more] | PTq3c2 + PTq3c3 >= 2) | | | | | | |
| | | OR | | | | | | | |
| | | R2 and R(interferes) any of 1 of 3 CB [1 or | PTq3r2 = 1 and PTq3r5 = 1 and (PTq3c1 + | | | ◯ | | ◯ | ◯ |
| | | more] | PTq3c2 + PTq3c3 >= 1) | | | | | | |

| Do- | Ques- | | | IP | | | | | |
|---|---|---|---|---|---|---|---|---|---|
| main | tion | Condition | CODE | (Med) | IP | PH | RTC | IOP | OP |
| PT | Q4 | R1 (on an invol hold) and CB1 OR CB2 OR CB3 | PTq4r1 = 1 and (PTq4c1 = 1 or PTq4c2 = 1 or | | ◯ | | | | |
| | | | PTq4c3 = 1) | | | | | | |
| | AND | | | | | | | | |
| S | Q4 | R1 (Sq4r1: acute state of intoxication) | Sq4r1 = 1 | | ◯ | | | | |
| | OR | | | | | | | | |
| | Q4 | R2 (Sq4r2: acute state of withdrawal) | Sq4r2 = 1 | | ◯ | | | | |
| | OR | | | | | | | | |
| L | Q8 | R1 (in acute state of intoxication) and CB1 OR | Lq8r1 = 1 and (Lq8c1 = 1 or Lq8c2 = 1 or | | ◯ | | | | |
| | | CB2 OR CB3 | Lq8c3 = 1) | | | | | | |
| PR | Q2 | Q2 Most recent level of care is “Detox/Inpatient | PRq2LOC = 3 | | | ◯ | ◯ | ◯ | |
| | | Rehab” | | | | | | | |
| | AND | | | | | | | | |
| | Q3 | if history of failure is PH or RTC and months | (PRq3c3 = 1 or PRq3c4 = 1) and | | ◯ | ◯ | ◯ | | |
| | | since last failure is 0-3 months | (PRq3mslf3 = 1 or PRq3mslf4 = 1) | | | | | | |
| | | OR | | | | | | | |
| | | if history of failure is PH or RTC and months | (PRq3c3 = 1 and (PRq3mslf3 = 2 or | | | ◯ | ◯ | ◯ | |
| | | since last failure is 3-6 months or more | PRq3mslf3 = 3)) or (PRq3c4 = 1 | | | | | | |
| | | | and (PRq3mslf4 = 2 or PRq3mslf4 = 3)) | | | | | | |
| | | OR | | | | | | | |
| | | if history of failure is IOP and months since last | PRq3c6 = 1 and PRq3mslf6 = 1 | | | ◯ | ◯ | ◯ | |
| | | failure is 0-3 months | | | | | | | |
| | | OR | | | | | | | |
| | | if history of failure is IOP and months since last | PRq3c6 = 1 and (PRq3mslf6 = 2 or | | | | | ◯ | ◯ |
| | | failure is 3-6 months or more | PRq3mslf6 = 3) | | | | | | |
| | AND | | | | | | | | |
| | Q1 | R1 and CB1 with subsequent CB1 or CB2 or | PRq1r01 = 1 and PRq1c1 = 1 and | | ◯ | | | | |
| | | CB3 | (PRq1c2 = 1 or PRq1c3 = 1 or | | | | | | |
| | | | PRq1c4 = 1) | | | | | | |
| | | OR | | | | | | | |
| | | R1 and CB2 with subsequent CB1 or CB2 | PRq1r01 = 1 and PRq1c5 = 1 and | | ◯ | | | | |
| | | | (PRq1c6 = 1 or PRq1c6 = 1) | | | | | | |
| | | OR | | | | | | | |
| | | R1 and CB4 with subsequent CB1 or CB2 | PRq1r01 = 1 and PRq1c9 = 1 and | | ◯ | ◯ | | | |
| | | | (PRq1c10 = 1 or PRq1c11 = 1) | | | | | | |
| | | OR | | | | | | | |
| | | R1 and CB3 | PRq1r01 = 1 and PRq1c8 = 1 | | | ◯ | ◯ | ◯ | |
| | | OR | | | | | | | |
| | | R1 and CB5 OR CB6 | PRq1r01 = 1 and (PRq1c12 = 1 | | | | | ◯ | ◯ |
| | | | or PRq1c13 = 1) | | | | | | |

| Do- | Ques- | | | IP | | | | | |
|---|---|---|---|---|---|---|---|---|---|
| main | tion | Condition | CODE | (Med) | IP | PH | RTC | IOP | OP |
| PR | Q2 | Q2 Most recent level of care is “Detox/Inpatient | PRq2LOC = 3 | | | ◯ | ◯ | ◯ | |
| | | Rehab” | | | | | | | |
| | AND | | | | | | | | |
| | Q3 | if history of failure is PH or RTC and months | (PRq3c3 = 1 or PRq3c4 = 1) and | | ◯ | ◯ | ◯ | | |
| | | since last failure is 0-3 months | (PRq3mslf3 = 1 or | | | | | | |
| | | | PRq3mslf4 = 1) | | | | | | |
| | | OR | | | | | | | |
| | | if history of failure is PH or RTC and months | (PRq3c3 = 1 and (PRq3mslf3 = 2 or | | | ◯ | ◯ | ◯ | |
| | | since last failure is 3-6 months or more | PRq3mslf3 = 3)) or (PRq3c4 = 1 and | | | | | | |
| | | | (PRq3mslf4 = 2 or PRq3mslf4 = 3)) | | | | | | |
| | | OR | | | | | | | |
| | | if history of failure is IOP and months since last | PRq3c6 = 1 and PRq3mslf6 = 1 | | | ◯ | ◯ | ◯ | |
| | | failure is 0-3 months | | | | | | | |
| | | OR | | | | | | | |
| | | if history of failure is IOP and months since last | PRq3c6 = 1 and (PRq3mslf6 = 2 or | | | | | ◯ | ◯ |
| | | failure is 3-6 months or more | PRq3mslf6 = 3) | | | | | | |
| | AND | | | | | | | | |
| | Q1 | R1 and CB1 with subsequent CB1 or CB2 or | PRq1r01 = 1 and PRq1c1 = 1 and | | ◯ | | | | |
| | | CB3 | (PRq1c2 = 1 or | | | | | | |
| | | | PRq1c3 = 1 or PRq1c4 = 1) | | | | | | |
| | | OR | | | | | | | |
| PR | Q2 | Q2 Most recent level of care is “Detox/Inpatient | PRq2LOC = 3 | | | | ◯ | ◯ | |
| | | Rehab” | | | | | | | |
| | AND | | | | | | | | |
| | Q3 | if history of failure is PH or RTC and months | (PRq3c3 = 1 or PRq3c4 = 1) and | | | | ◯ | | |
| | | since last failure is 0-3 | (PRq3mslf3 = 1 or PRq3mslf4 = 1) | | | | | | |
| | | OR | | | | | | | |
| | | if history of failure is PH or RTC and months | (PRq3c3 = 1 and (PRq3mslf3 = 2 or | | | | ◯ | ◯ | |
| | | since last failure is 3-6 months or more | PRq3mslf3 = 3)) or (PRq3c4 = 1 and | | | | | | |
| | | | (PRq3mslf4 = 2 or PRq3mslf4 = 3)) | | | | | | |
| | | OR | | | | | | | |
| | | if history of failure is IOP and months since last | PRq3c6 = 1 and PRq3mslf6 = 1 | | | | ◯ | ◯ | |
| | | failure is 0-3 or 3-6 | | | | | | | |
| | | OR | | | | | | | |
| | | if history of failure is IOP and months since last | PRq3c6 = 1 and (PRq3mslf6 = 2 or | | | | | ◯ | ◯ |
| | | failure is 3-6 months or more | PRq3mslf6 = 3) | | | | | | |
| | AND | | | | | | | | |
| | Q3 | number of episodes in SA Detox/Rehab 3 or | PRq3noe9 >= 3 | | | | ◯ | X | |
| | | more | | | | | | | |
| | | OR | | | | | | | |
| | | number of episodes in SA Detox/Rehab 0 to 2 | PRq3noe9 <= 2 | | | | | X | ◯ |
| | AND | | | | | | | | |
| P | Q2 | R1 (high risk environment) AND FIRST CHECK | Pq2r1 = 1 and Pq2c1 = 1 and (Pq2c2 = 1 | | | | ◯ | ◯ | |
| | | BOX, and then CB1 OR CB2 OR CB3 focus on | or Pq2c3 = 1 or Pq2c12 = 1) | | | | | | |
| | | alc/drug abuse | | | | | | | |
| | | OR | | | | | | | |
| | | R2 (not a high risk environment) | Pq2r2 = 1 | | | | | ◯ | ◯ |
| | AND | | | | | | | | |
| | Q6 | R1 OR R3 | Pq6r1 = 1 or Pq6r3 = 1 | | | | ◯ | | |
| | | OR | | | | | | | |
| | | R2 | Pq6r2 = 1 | | | | | ◯ | ◯ |

### Appendix C

### Level of Care Criteria

IP: Inpatient

| | | | PsychoSocial | Functional | Medical | Patient | Provider |
|---|---|---|---|---|---|---|---|
| | Symptoms | Lethality | Support | Impairment | Conditions | Resources | Resources |
| IP | Domain 1 | Domain 2 | Domain 3 | Domain 4 | Domain 5 | Domain 6 | Domain 7 |
| Do- | S4 or S3 or | Lq2r1 | | | | | PRq1r01 and PRq1c1 and PRq1c2 |
| main 1 | S2 or S1 | | | | | | |
| | S4 or S3 or | Lq11r1 and | | | | | PRq1r01 and PRq1c1 and PRq1c2 |
| | S2 or S1 | (Lq11c1 or Lq11c2) | | | | | |
| | S4 or S3 or | | | | | | PRq1r01 and PRq1c1 and (PRq1c3 or PRq1c4) |
| | S2 or S1 | | | | | | |
| | S4 or S3 or | | | | | | PRq1r01 and PRq1c5 and PRq1c6 |
| | S2 or S1 | | | | | | |
| | S4 or S3 or | Lq2r1 | | | | | PRq1r02 and PRq1c1 and PRq1c2 and PRq1r1 |
| | S2 or S1 | | | | | | |
| | S4 or S3 or | Lq11r1 and | | | | | PRq1r02 and PRq1c1 and PRq1c2 and PRq1r1 |
| | S2 or S1 | (Lq11c1 or Lq11c2) | | | | | |
| | S4 or S3 or | | | | | | PRq1r02 and PRq1c1 and ((PRq1c3 and |
| | S2 or S1 | | | | | | PRq1r4) or (PRq1c [symbol] |
| | S4 or S3 or | | | | | | PRq1r02 and PRq1c5 and PRq1c6 and |
| | S2 or S1 | | | | | | PRq1r10 |
| | S4 or S3 or | | | | | | PRq1r02 and PRq1c8 and PRq1r16 |
| | S2 or S1 | | | | | | |
| | S4 | | | | | | (PRq2LOC >= 1 and PRq2LOC <= 5) and |
| | | | | | | | (PRq2OUTCOME [symbol] |
| | S3 or S2 | | | | | | (PRq2LOC >= 1 or PRq2LOC <= 3) and |
| | | | | | | | (PRq2OUTCOME > [symbol] |
| Do- | | LF REMOVED THE CONDITION | | | | | |
| main 2 | | THAT REQUIRED ONLY L4 | | | | | |
| | | L4 or L3 | | | | | PRq1r01 and PRq1c1 and PRq1c2 |
| | | L4 or L3 | | | | | PRq1r01 and PRq1c5 and PRq1c6 |
| | | L4 or L3 | | | | | PRq1r01 and PRq1c8 |
| | | L4 or L3 and (Lq11r1 and | | | | | PRq1r02 and PRq1c1 and PRq1c2 and |
| | | (Lq11c1 or Lq11c2)) | | | | | PRq1r1 |
| | | L4 or L3 | | | | | PRq1r02 and PRq1c5 and PRq1c6 and |
| | | | | | | | PRq1r10 |
| | | L4 or L3 | | | | | PRq1r02 and PRq1c8 and PRq1r16 |
| | | L4 or L3 | (Pq6r1 or Pq6r3 | | | | |
| | | | or Pq5r1) | | | | |
| Do- | | Lq11r1 and | P4 | | | | |
| main 3 | | (Lq11c1 or Lq11c2) | | | | | |
| | S4 | | P4 | Fq1r1 and (Fq1c1 or | | | |
| | | | | Fq1c2 or Fq1c3) | | | |
| | S4 | | P4 | Fq2r1 and (Fq2c1 or Fq2c2) | | | |
| | | | | and (Fq2r2 or (Fq2r3 and Fq2r4)) | | | |
| | S4 | | P4 | Fq3r1 and (Fq3c1 or | | | |
| | | | | Fq3c2) | | | |
| | S4 | | P4 | Fq7r1 or Fq7r2 | | | |
| | S4 | | P4 | Fq8r1 | | | |
| Do- | | | | F4 or F3 | | (PTq3r1 or PTq3r2) and PTq3r5.(PRq3c3 = 1 and | |
| main 4 | | | | | | PRq3c11 = 1 and PRq3mslf3 = 1) or (PRq3 [symbol] | |
| | | | | F4 or F3 | | (PTq3r1 or PTq3r2) and PTq3r5.((PRq3c3 = 1 and | |
| | | | | | | PRq3c11 = 1 and PRq3mslf3 > 1) or (PRq [symbol] | |
| Do- | S4 or S3 | | Pq5r1 or Pq5r2 | | M4 or M3 | (PTq3r1 or PTq3r2) and PTq3r5.(PRq3c3 = 1 and | |
| main 5 | | | | | | PRq3c11 = 1 and PRq3mslf3 = 1) or (PRq3 [symbol] | |
| | S4 or S3 | | Pq5r1 or Pq5r2 | | M4 or M3 | (PTq3r1 or PTq3r2) and PTq3r5.(PRq3c3 = 1 and | |
| | | | | | | PRq3c11 = 1 and PRq3mslf3 > 1) or (PRq3 [symbol] | |
| Do- | | | | | | PTq4r1 and (PTq4c1 or PTq4c2 or PTq4c3) | |
| main 6 | | | | | | | |
| | | Lq11r1 and | Pq6r1 or Pq6r3 | | | (PTq4r2 or PTq4r3) and (PTq4c1 or PTq4c2 | |
| | | (Lq11c1 or Lq11c2) | | | | or PTq4c3) | |
| Do- | | | | | | | |
| main 7 | | | | | | | |

[symbol]

indicates data missing or illegible when filed

RTC: Residential Treatment Center

| | | | PsychoSocial | Functional | Medical | Patient | Provider |
|---|---|---|---|---|---|---|---|
| | Symptoms | Lethality | Support | Impairment | Conditions | Resources | Resources |
| RTC | Domain 1 | Domain 2 | Domain 3 | Domain 4 | Domain 5 | Domain 6 | Domain 7 |
| Do- | (Symptoms = 4 or Symptoms = 3 or Symptoms = 2) | | | | | PTq3r4 = 1 or ((PTq3r1 = 1 or PT PRq1r01 = | |
| main 1 | an [symbol] Pq6r1 = 1 or Pq6r3 = 1 or Pq5r1 = 1 | | | | | 1 and ((PRq1c5 = 1 and PRq1c7 = 1) or PRq1c8 = [symbol] | |
| | (Symptoms = 4 or Symptoms = 3 or Symptoms = 2) | | | | | PTq3r4 = 1 or ((PTq3r1 = 1 or PT PRq1r01 = | |
| | an [symbol] Pq6r1 = 1 or Pq6r3 = 1 or Pq5r1 = 1 | | | | | 1 and ((PRq1c5 = 1 and PRq1c7 = 1) or PRq1c8 = [symbol] | |
| | (Symptoms = 4 or Symptoms = 3 or Symptoms = 2) | | | | | PTq3r4 = 1 or ((PTq3r1 = 1 or PT PRq1r02 = | |
| | an [symbol] Pq6r1 = 1 or Pq6r3 = 1 or Pq5r1 = 1 | | | | | 1 and (((PRq1c5 = 1 and (PRq1c7 = 1 and (PRq1 [symbol] | |
| | (Symptoms = 4 or Symptoms = 3 or Symptoms = 2) | | | | | PTq3r4 = 1 or ((PTq3r1 = 1 or PT PRq1r02 = | |
| | an [symbol] Pq6r1 = 1 or Pq6r3 = 1 or Pq5r1 = 1 | | | | | 1 and (((PRq1c5 = 1 and (PRq1c7 = 1 and (PRq1 [symbol] | |
| Do- | | Lethality = 3 or | PsychSocial = 4 | | | | PRq1r01 = 1 and ((PRq1c5 = |
| main 2 | | Lethality = 2 | | | | | 1 and PRq1c7 = 1) or PRq1c8 [symbol] |
| | | Lethality = 3 or | PsychSocial = 4 | | | | PRq1r01 = 1 and ((PRq1c5 = |
| | | Lethality = 2 | | | | | 1 and PRq1c7 = 1) or PRq1c8 [symbol] |
| | | Lethality = 3 or | PsychSocial = 4 | | | | PRq1r02 = 1 and (((PRq1c5 = |
| | | Lethality = 2 | | | | | 1 and (PRq1c7 = 1 and (PRq1 [symbol] |
| | | Lethality = 3 or | PsychSocial = 4 | | | | PRq1r02 = 1 and (((PRq1c5 = |
| | | Lethality = 2 | | | | | 1 and (PRq1c7 = 1 and (PRq1 [symbol] |
| Do- | | | | | | | |
| main 3 | | | | | | | |
| Do- | (Symptoms = 4 or Symptoms = 3 or Symptoms = 2) and | | | F4 or F3 | | (PTq3r4 = 1 or ((PTq3r1 = 1 or P [symbol] (PRq3c3 = | |
| main 4 | S [symbol] Pq5r1 = 1 or Pq5r2 = 1 | | | | | 1 and PRq3c11 = 1 and PRq3mslf3 = 1) or (PRq3 [symbol] | |
| | (Symptoms = 4 or Symptoms = 3 or Symptoms = 2) and | | | F4 or F3 | | (PTq3r4 = 1 or ((PTq3r1 = 1 or P [symbol] ((PRq3c3 = | |
| | S [symbol] Pq5r1 = 1 or Pq5r2 = 1 | | | | | 1 and PRq3c11 = 1 and PRq3mslf3 > 1) or (PRq [symbol] | |
| | (Symptoms = 4 or Symptoms = 3 or Symptoms = 2) and | | | F4 or F3 | | | (PRq3c3 = 1 and PRq3c11 = 1 |
| | S [symbol] PsychSocial = 4 | | | | | | and PRq3mslf3 = 1) or (PRq3 [symbol] |
| | (Symptoms = 4 or Symptoms = 3 or Symptoms = 2) and | | | F4 or F3 | | | ((PRq3c3 = 1 and PRq3c11 = 1 |
| | S [symbol] PsychSocial = 4 | | | | | | and PRq3mslf3 > 1) or (PRq [symbol] |
| Do- | (Symptoms = 4 or Symptoms = 3 or Symptoms = 2) and | | | | Medical = 3 or | | PRq1r01 = 1 and ((PRq1c5 = |
| main 5 | S [symbol] Pq2r1 = 1 and (Pq2c1 = 1 or Pq2c4 = 1 or Pq2c7 | | | | Medical = 2 | | 1 and PRq1c7 = 1) or PRq1c8 [symbol] |
| | (Symptoms = 4 or Symptoms = 3 or Symptoms = 2) and | | | | Medical = 3 or | | PRq1r01 = 1 and ((PRq1c5 = |
| | S [symbol] Pq2r1 = 1 and (Pq2c1 = 1 or Pq2c4 = 1 or Pq2c7 | | | | Medical = 2 | | 1 and PRq1c7 = 1) or PRq1c8 [symbol] |
| | (Symptoms = 4 or Symptoms = 3 or Symptoms = 2) and | | | | Medical = 3 or | | PRq1r02 = 1 and (((PRq1c5 = |
| | S [symbol] Pq2r1 = 1 and (Pq2c1 = 1 or Pq2c4 = 1 or Pq2c7 | | | | Medical = 2 | | 1 and (PRq1c7 = 1 and (PRq1 [symbol] |
| | (Symptoms = 4 or Symptoms = 3 or Symptoms = 2) and | | | | Medical = 3 or | | PRq1r02 = 1 and (((PRq1c5 = |
| | S [symbol] Pq2r1 = 1 and (Pq2c1 = 1 or Pq2c4 = 1 or Pq2c7 | | | | Medical = 2 | | 1 and (PRq1c7 = 1 and (PRq1 [symbol] |
| Do- | | | | | | | |
| main 6 | | | | | | | |

| | |
|---|---|
| Do- | (Symptoms = 4 or Symptoms = 3 or Symptoms = 2) and Sq4r1 <> 1 and (Sq4MedicFq1r2 = 1 and |
| main 7 | (Fq1c1 = 1 or Fq1c2 = 1 or Fq1 [symbol] PTq3r4 = 1 or ((PTq3r1 = 1 or PT (PRq1r01 = 1 and |
| | ((PRq1c5 = 1 and PRq1c7 = 1) or PRq1c8 [symbol] |
| | (Symptoms = 4 or Symptoms = 3 or Symptoms = 2) and Sq4r1 <> 1 and (Sq4Medic Fq1r2 = 1 and |
| | (Fq1c1 = 1 or Fq1c2 = 1 or Fq1 [symbol] PTq3r4 = 1 or ((PTq3r1 = 1 or PT (PRq1r01 = 1 and |
| | ((PRq1c5 = 1 and PRq1c7 = 1) or PRqc8 [symbol] |

[symbol]

indicates data missing or illegible when filed

PH: Partial Hospital Program

| | | | PsychoSocial | Functional | Medical | Patient | Provider |
|---|---|---|---|---|---|---|---|
| | Symptoms | Lethality | Support | Impairment | Conditions | Resources | Resources |
| PH | Domain 1 | Domain 2 | Domain 3 | Domain 4 | Domain 5 | Domain 6 | Domain 7 |
| Do- | (Symptoms = 4 or Symptoms = 3 or | | | | | (PTq1r3 = 1 or PTq1r4 = 1) and ( [symbol] PRq1r01 = 1 | |
| main 1 | Symptoms = 2) an [symbol] Pq6r2 = 1 | | | | | and ((PRq1r5 = 1 and PRq1r7 = 1) or PRq1r8 = [symbol] | |
| | (Symptoms = 4 or Symptoms = 3 or | | | | | (PTq1r3 = 1 or PTq1r4 = 1) and ( [symbol] PRq1r01 = 1 | |
| | Symptoms = 2) an [symbol] Pq6r2 = 1 | | | | | and ((PRq1r5 = 1 and PRq1r7 = 1) or PRq1r8 = [symbol] | |
| | (Symptoms = 4 or Symptoms = 3 or | | | | | (PTq1r3 = 1 or PTq1r4 = 1) and ( [symbol] PRq1r02 = 1 | |
| | Symptoms = 2) an [symbol] Pq6r2 = 1 | | | | | and ((PRq1c5 and PRq1c7 and PRq1r13) or (P [symbol] | |
| | (Symptoms = 4 or Symptoms = 3 or | | | | | (PTq1r3 = 1 or PTq1r4 = 1) and ( [symbol] PRq1r02 = 1 | |
| | Symptoms = 2) an [symbol] Pq6r2 = 1 | | | | | and ((PRq1c5 and PRq1c7 and PRq1r13) or (P [symbol] | |
| Do- | | L3 or L2 | P3 | | | | PRq1r01 = 1 and ((PRq1r5 = 1 and |
| main 2 | | | | | | | PRq1r7 = 1) or PRq1r8 = [symbol] |
| | | L3 or L2 | P3 | | | | PRq1r01 = 1 and ((PRq1r5 = 1 and |
| | | | | | | | PRq1r7 = 1) or PRq1r8 = [symbol] |
| | | L3 or L2 | P3 | | | | PRq1r02 = 1 and ((PRq1c5 and PRq1c7 |
| | | | | | | | and PRq1r13) or (P [symbol] |
| | | L3 or L2 | P3 | | | | PRq1r02 = 1 and ((PRq1c5 and PRq1c7 |
| | | | | | | | and PRq1r13) or (P [symbol] |
| Do- | | | | | | | |
| main 3 | | | | | | | |
| Do- | (Symptoms = 4 or Symptoms = 3 or Symptoms = 2) and | | | F4 or F3 | | (PTq1r3 = 1 or PTq1r4 = 1) and ( [symbol] ((PRq3c5 = 1 | |
| main 4 | S [symbol] Pq5r4 = 1 | | | | | and PRq3c13 = 1 and PRq3mslf5 = 1) or (PRq [symbol] | |
| | (Symptoms = 4 or Symptoms = 3 or Symptoms = 2) and | | | F4 or F3 | | (PTq1r3 = 1 or PTq1r4 = 1) and ( [symbol] ((PRq3c5 = 1 | |
| | S [symbol] Pq5r4 = 1 | | | | | and PRq3c13 = 1 and PRq3mslf5 > 1) or (PRq [symbol] | |
| Do- | (Symptoms = 4 or Symptoms = 3 or Symptoms = 2) and | | | | M4 | | PRq1r01 = 1 and ((PRq1r5 = 1 and |
| main 5 | Sq4r1 <> 1 and (Sq4Medical_Unit_symptoms = 0 a [symbol] | | | | | | PRq1r7 = 1) or PRq1r5 = [symbol] |
| | (Symptoms = 4 or Symptoms = 3 or Symptoms = 2) and | | | | M4 | | PRq1r01 = 1 and ((PRq1r5 = 1 and |
| | Sq4r1 <> 1 and (Sq4Medical_Unit_symptoms = 0 a [symbol] | | | | | | PRq1r7 = 1) or PRq1r5 = [symbol] |
| | (Symptoms = 4 or Symptoms = 3 or Symptoms = 2) and | | | | M4 | | PRq1r02 = 1 and ((PRq1c5 and PRq1c7 |
| | Sq4r1 <> 1 and (Sq4Medical_Unit_Symptoms = 0 a [symbol] | | | | | | and PRq1r13) or (P [symbol] |
| | (Symptoms = 4 or Symptoms = 3 | | | | M4 | | PRq1r02 = 1 and ((PRq1c5 and PRq1c7 |
| | or Symptoms = 2) and | | | | | | and PRq1r13) or (P [symbol] |
| | Sq4r1 <> 1 and (Sq4Medical_Unit_Symptoms = 0 a [symbol] | | | | | | |
| Do- | | | | | | | |
| main 6 | | | | | | | |

| | |
|---|---|
| Do- | (Symptoms = 4 or Symptoms = 3 or Symptoms = 2) and Sq4r1 <> 1 and (Sq4Medic Fq1r2 and |
| main 7 | (Fq1c1 or Fq1c2 or Fq1c3 or Fq1c4 PTq3r4 = 1 or ((PTq3r1 = 1 or PT PRq1r01 = 1 and |
| | ((PRq1c5 = 1 and PRq1c7 = 1) or PRq1c8 [symbol] |
| | (Symptoms = 4 or Symptoms = 3 or Symptoms = 2) and Sq4r1 <> 1 and (Sq4MedicFq1r2 and |
| | (Fq1c1 or Fq1c2 or Fq1c3 or Fq1c4 PTq3r4 = 1 or ((PTq3r1 = 1 or PT PRq1r01 = 1 and |
| | ((PRq1c5 = 1 and PRq1c7 = 1) or PRq1c8 [symbol] |

[symbol]

indicates data missing or illegible when filed

IOP: Intensive Outpatient

| | | | | PsychoSocial | Functional |
|---|---|---|---|---|---|
| | | Symptoms | Lethality | Support | Impairment |
| | IOP | Domain 1 | Domain 2 | Domain 3 | Domain 4 |
| 1 | Domain 1 | S4 or S3 | | | |
| 2 | | S2 or S1 | | | |
| 3 | Domain 2 | | L3 or L2 or L1 | (#3) in P3 or P2 | |
| 4 | Domain 3 | | | P3 | |
| 5 | | (#1 or #2)in S4 or S3 | | P2 | |
| 6 | | | | P2 | (#1 or #2)in F4 or F3 |
| 7 | | | | P2 | |
| 8 | Domain 4 | | | (#3) in P3 or P2 | F4 |
| 9 | | | | | F3 or F2 or F1 |
| 10 | Domain 5 | | L4 or L3 or L2 not present | | |
| 11 | | | L4 OR L3 OR L2 | (#3) in P3 or P2 | |
| 12 | | | | | |
| 13 | Domain 6 | | L2 | | |
| 14 | | | | P2 | |
| 15 | | S1 | L1 | | |
| 16 | | | L1 | | F1 |
| 17 | | | L1 | | |
| 18 | | S1 | L2 or L3 | (#3) in P3 or P2 | |
| 19 | | | L2 or L3 | (#3) in P3 or P2 | F1 |
| 20 | | | L2 or L3 | (#3) in P3 or P2 | |
| | Domain 7 | | | | |

| | | Medical | Patient | Provider |
|---|---|---|---|---|
| | | Conditions | Resources | Resources |
| | IOP | Domain 5 | Domain 6 | Domain 7 |
| 1 | Domain 1 | | Pt(#1 + #2) | |
| 2 | | | Pt(#1 + #2) | Pr(#2 OR #3)) |
| 3 | Domain 2 | | | Pr(#2) |
| 4 | Domain 3 | | Pt(#1 + #2) | Pr(#2) |
| 5 | | | Pt(#1 + #2) | |
| 6 | | | Pt(#1 + #2) | |
| 7 | | (#1 or #2)in H4 or H3 | Pt(#1 + #2) | |
| 8 | Domain 4 | | | Pr(#2) |
| 9 | | | Pt(#1 + #2) | Pr(#2 OR #3)) |
| 10 | Domain 5 | M4 or M3 | | Pr(#2) |
| 11 | | M4 or M3 | | Pr(#2) |
| 12 | | M2 or M1 | Pt(#1 + #2) | Pr(#2 OR #3)) |
| 13 | Domain 6 | | Pt(#1 + #2 + #3 + #4) | Pr(#2 OR #3)) |
| 14 | | | Pt(#1 + #2 + #3 + #4) | Pr(#2 OR #3)) |
| 15 | | | Pt(#1 + #2 + #3 + #4) | Pr(#2 OR #3)) |
| 16 | | | Pt(#1 + #2 + #3 + #4) | Pr(#2 OR #3)) |
| 17 | | M1 | Pt(#1 + #2 + #3 + #4) | Pr(#2 OR #3)) |
| 18 | | | Pt(#1 + #2 + #3 + #4) | Pr(#2 OR #3)) |
| 19 | | | Pt(#1 + #2 + #3 + #4) | Pr(#2 OR #3)) |
| 20 | | M1 | Pt(#1 + #2 + #3 + #4) | Pr(#2 OR #3)) |
| | Domain 7 | | | |

OP: Outpatient Services

| | | | PsychoSocial | Functional | Medical | Patient | Provider |
|---|---|---|---|---|---|---|---|
| | Symptoms | Lethality | Support | Impairment | Conditions | Resources | Resources |
| OP | Domain 1 | Domain 2 | Domain 3 | Domain 4 | Domain 5 | Domain 6 | Domain 7 |
| Domain 1 | S4 | | | | | | |
| | S3 or S2 or S1 | | | | | Pt(#1 + #2) | |
| Domain 2 | | L3 or L2 or L1 | (#3) in P3 or P2 | | | | |
| Domain 3 | | | P3 | | | Pt(#1 + #2):no/low | |
| | | | | | | motivation AND no/low compliance | |
| | S1 | | P2 | | | Pt(#1 + #2) | |
| | | | P2 | F1 | | Pt(#1 + #2) | |
| | | | P2 | | M1 | Pt(#1 + #2) | |
| Domain 4 | | | (#3) in P3 or P2 | F4 | | | |
| | | | | F3 or F2 or F1 | | Pt(#1 + #2) | |
| Domain 5 | | L4 or L3 or L2 not present | | | M4 or M3 | | |
| | | L4 or L3 or L2 | (#3) in P3 or P2 | | M4 or M3 | | |
| | | | | | M2 or M1 | Pt(#1 + #2) | |
| Domain 6 | S1 | | | | | Pt(#1 + #2 + #3 + #4) | Pr(#3) |
| | | L1 | | | | Pt(#1 + #2 + #3 + #4) | Pr(#3) |
| | | | P1 OR P2 | | | Pt(#1 + #2 + #3 + #4) | Pr(#3) |
| | | | | F1 | | Pt(#1 + #2 + #3 + #4) | Pr(#3) |
| | | | | | M1 | Pt(#1 + #2 + #3 + #4) | Pr(#3) |
| | | L2 or L3 | (#3) in P3 or P2 | | | Pt(#1 + #2 + #3 + #4) | Pr(#3) |
| Domain 7 | | | | | | | |

1. A computer implemented method for managing a patient's clinical status, the method comprising:
storing a plurality of rules in a database;
storing a plurality of clinical domains in the database, each clinical domain including a set of clinical variables;
storing information about the patient in the database;
receiving responses to one or more questions about the patient's status for one or more clinical domains;
generating derived variables from the stored information, the stored clinical variable and the responses to one or more questions using one or more of the stored plurality of rules;
calculating stratified domain levels for one or more of the plurality of clinical domains from the stored information, the stored clinical variables and the generated derived variables; and
calculating a level of care from the stratified domain levels and the generated derived variables.

2. The method of claim 1, further comprising calculating a level of urgency from the stratified domain levels and the generated derived variables.

3. The method of claim 1, further comprising generating a report based on the stored information about the patient and the calculated level of care.

4. The method of claim 1, wherein the clinical variables are selected based on clinical research to describe clinical acuity and determine risk.

5. The method of claim 1, wherein the stratified domain levels for a domain define multiple levels of severity for said domain.

6. The method of claim 1, further comprising providing a plurality of criteria to map responses in each domain to the stratified domain levels for said domain.

7. The method of claim 1, wherein the level of care includes one or more of the group consisting of inpatient, residential treatment program, partial hospital program, intensive outpatient program, and outpatient services.

8. The method of claim 1, wherein the plurality of clinical domains includes one or more of the group consisting of symptom severity, lethality, psychosocial support, functional impairment, medical co-morbidity, patient resources, and provider resources.

9. The method of claim 2, wherein the level of urgency includes one or more of the group consisting of emergency, urgent, and routine.

10. The method of claim 1, further comprising: assigning a numerical score to each domain based on the responses received for a respective domain; computing scores for each domain based on the numerical values for the respective domain; and generating and displaying a graph of domain scores as a representation of the patient's clinical profile.

11. The method of claim 2, further comprising generating a severity score for one or more of the domains.

12. The method of claim 2, further comprising creating a plurality of gap equations including a nearest anchor criteria to account for unanswered questions in each domain and mapping each gap equation to a stratification domain level based on a predetermined degree to which said each gap equation is deviated from its nearest anchor criteria.

13. A computer implemented method for managing a patient's clinical status, the method comprising:
storing a plurality of rules in a database;
storing a plurality of clinical domains in the database, each clinical domain including a set of clinical variables;
storing information about the patient in the database;
receiving responses to one or more questions about the patient's status for one or more clinical domains;
generating derived variables from the stored information, the stored clinical variables and the responses to one or more questions using one or more of the stored plurality of rules;
calculating stratified domain levels for one or more of the plurality of clinical domains from the stored information, the stored clinical variables and the generated derived variables; and
calculating a level of urgency from the stratified domain levels and the generated derived variables.

14. The method of claim 13, further comprising calculating a level of care from the stratified domain levels and the generated derived variables.

15. The method of claim 13, further comprising generating a report based on the stored information about the patient and the calculated level of care.

16. The method of claim 13, wherein the clinical variables are selected based on clinical research to describe clinical acuity and determine risk.

17. The method of claim 13, wherein the stratified domain levels for a domain define multiple levels of severity for said domain.

18. A computer implemented method for managing a patient's clinical status, the method comprising:
storing a plurality of rules and a plurality of clinical domains in a database, each clinical domain including a set of clinical variables selected based on clinical research to describe clinical acuity and determine risk;
defining a plurality of levels of care representing the patient's clinical status;
receiving responses to one or more questions about the patient's status for one or more clinical domains;
generating derived variables from the responses to one or more questions using one or more of the stored plurality of rules;
stratifying a patient's status in each clinical domain to represent a clinical severity level for each clinical domain;
joining the clinical severity levels across the plurality of clinical domains with the generated derived variables and the responses; and
mapping the clinical severity levels to medical necessity criteria related to each of the plurality of levels of care; and
generating a report based on the mapped the clinical severity levels and the levels of care.

19. The method of claim 18, further comprising calculating a level of urgency from the stratified d patient's status and the generated derived variables.

20. The method of claim 18, wherein the plurality of clinical domains includes one or more of the group consisting of symptom severity, lethality, psychosocial support, functional impairment, medical co-morbidity, patient resources, and provider resources.
